(19) United States
(12) Patent Application Publication
(10) Pub. No.: US 2006/0019189 A1
(43) Pub. Date: Jan. 26, 2006

(54) Image forming apparatus and an image forming method

(75) Inventors: Masao Asano, Tokyo (JP); Hiroshi Yamazaki, Tokyo (JP); Shigeki Takenouchi, Tokyo (JP); Akihiko Itami, Tokyo (JP); Satoshi Uchino, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Holdings, Inc., Tokyo (JP)

(21) Appl. No.: 10/895,709

(22) Filed: Jul. 21, 2004

(51) Int. Cl. G03G 15/16

(52) U.S. Cl. 430/126; 430/120; 430/124

(57) ABSTRACT

An image forming apparatus is provided with an electrophotographic photoreceptor on which a latent image is formed; and an agent providing device to provide a surface energy lowering agent having a water content ratio of 5.0 weight % or less onto the surface of the photoreceptor.

### BACKGROUND

1. Technical Field

The present invention relates to a copying machine, a printer, an image forming device used by facsimile equipment, an imaging method.

2. Related Art

Conventionally, as a method for transfer of a toner image which is on an electrophotographic photoreceptor (hereinafter, also referred to merely as a photoreceptor) onto a recording material for a final image, there is known a method of direct transfer of a toner image formed on an electrophotographic photoreceptor onto a recording material. On the other hand, there is known an image forming system, the system using an intermediate transfer member, in which a transfer process of transferring a toner image from an electrophotographic photoreceptor to a recording material incorporates another transfer process, wherein the toner image is primarily transferred from the electrophotographic photoreceptor to the intermediate transfer member, then the primary transfer image in the intermediate transfer member is secondarily transferred to the recording member, thereby the image forming system obtaining a final image.

An intermediate transfer system as described above is mostly employed as a superimposing transfer system that superimposes toner images of respective colors in a so-called full color image forming apparatus, wherein the superimposing transfer system reproduces an original image, the original image having been color-separated, with use of a subtractive mixture of toners of black, cyan, magenta, yellow, etc.

However, when a large number of document sheets is copied or printed, toner filming occurs on an electrophotographic photoreceptor and an intermediate transfer member; the surface energy of the electrophotographic photoreceptor and the intermediate transfer member grows and the adhesion force to toner increases; transferability of the toner from the electrophotographic photoreceptor or the intermediate transfer member to a recording material is reduced; and thus, image defects easily occur on a final image.

Especially, an image forming system using an intermediate transfer member has two transfer processes, which are a transfer process, as primary transfer means, that performs a primary transfer of a toner image from an electrophotographic photoreceptor to the intermediate transfer member, and another transfer process, as secondary transfer means, that transfers the toner image from the intermediate transfer member to a recording material. Since such an image forming system has two transfer processes as described above, degradation of transferability remarkably degrades the quality of final images.

Concretely, if transferability of toners degrades in an image forming system using an intermediate transfer member, a problem that a part of a toner image is not transferred, that is, so-called “hollow defects (racking of partial image)” or “character blurring (character image scattering)” occurs.

For improvement of transferability which may cause “hollow defects” or “character blurring”, prevention of toner filming, and improvement of incomplete cleaning, there has been discussion about technologies that provide micro particles in the surface layer of an electrophotographic photoreceptor, form irregularities on the surface thereof, reduce adhesion force of toner to the surface of the photoreceptor, improve transferability, and decrease friction force against a blade.

In TOKKAI No. H05-181291, for example, it is reported that micro particles of alkyl sill sesqui oxane resin are provided in a photoreceptive layer. However, micro particles of alkyl sill sesqui oxane resin are hygroscopic, therefore, in a high moisture environment, wetness of the surface of a photoreceptor, that is, the surface energy increases, accordingly there may occur a problem that transferability decreases.

In TOKKAI No. S63-56658, an electrophotographic photoreceptor provided with fluoride resin powder to lower the surface energy of the surface of a photoreceptor is reported. However, there is a problem that fluoride resin powder does not achieve enough surface strength, and streak defects due to scratches on the photoreceptor surface easily occur.

On the other hand, regarding improvement of the transferability of an intermediate transfer member, there are disclosed technologies that provide an intermediate transfer member with a solid lubricant to decrease the surface energy of the intermediate transfer member.

For example, TOKKAI No. H06-337598, TOKKAI No. H06-332324, and TOKKAI No. H07-271142 disclose such technologies. However, such a control of the surface of an intermediate transfer member is not enough to improve total transferability of an image forming system using an intermediate transfer member and having two transfer processes. Particularly, when forming copy images in an environment of a high temperature and high humidity or for a long period, further improvement is required. This situation is found out.

Specifically, to perform an image forming method employing an intermediate transfer member, it has been desired that both the surface energies of an electrophotographic photoreceptor and an intermediate transfer member be reduced with a proper balance so that the total transferability of both the primary and secondary transfers is improved.

On the other hand, in view of electrophotographic process, latent image forming methods can be categorized into analog image forming with a halogen lamp light source and digital image forming with a LED or laser light source. Recently, latent image forming in digital form is rapidly becoming dominant to be applied to a printer of a personal computer, and also to a common copy machine because of easy image processing as well as easy expansion to a multi functional machine.

Image forming in digital form is applied to copying, but in addition, more and more methods of creating original images in digital form have come to be adopted, wherein a higher image quality tends to be required in electrophotographic image forming in digital form.

In response to the requirement for the high image quality, although a study has been undertaken to faithfully create a visual image of a latent image on an electrophotographic photoreceptor by the use of a toner of fine particles prepared by control of shape factors and particle size distribution, transferability of the toner and improvement effect on cleanability have been increased not so much as expected initially, even when such a toner is applied to the image forming method employing an intermediate transfer member, resulting in creation of hollow defects and character blurring.

The image forming method employing an intermediate transfer member requires adjusting the balance between the surface energies of the electrophotographic photoreceptor and the intermediate transfer member, and improving the characteristics of toner to match an intermediate transfer method so that the total transferability of toner in both the primary transfer and the secondary transfer is improved. This situation has been found.

### SUMMARY

An image forming method comprising:
developing a latent image on an electrophotographic photoreceptor with a developer containing toner, and the
providing surface of the photoreceptor with a surface energy lowering agent with a water content ratio of 5.0 weight percent or lower.

### BRIEF DESCRIPTION OF THE DRAWINGS

The present invention will become more fully understood from the detailed description given herein below and the accompanying drawings which are given by way of illustration only, and thus are not intended as a definition of the limits of the present invention, and wherein;

FIG. 1 is a cross-sectional construction diagram of a color image forming apparatus, showing an embodiment of the invention;

FIG. 2 shows an example of a cleaning device of an intermediate transfer member;

FIG. 3 is an arrangement diagram showing an example of the position relationship between a photoreceptor, an endless-belt shape intermediate transfer member, and a primary transfer roller;

FIG. 4 is an arrangement diagram showing an example of the position relationship between a backup roller, the endless-belt shape intermediate transfer member, and a secondary transfer roller; and

FIG. 5 is a construction diagram of an example of a cleaning device installed at a photoreceptor in the invention.

FIG. 6 is a diagram explaining a portion for measuring a contact angle.

### DETAIL DESCRIPTION OF EXEMPLARY EMBODIMENTS

The invention will be described below in more detail, according to exemplary embodiments.

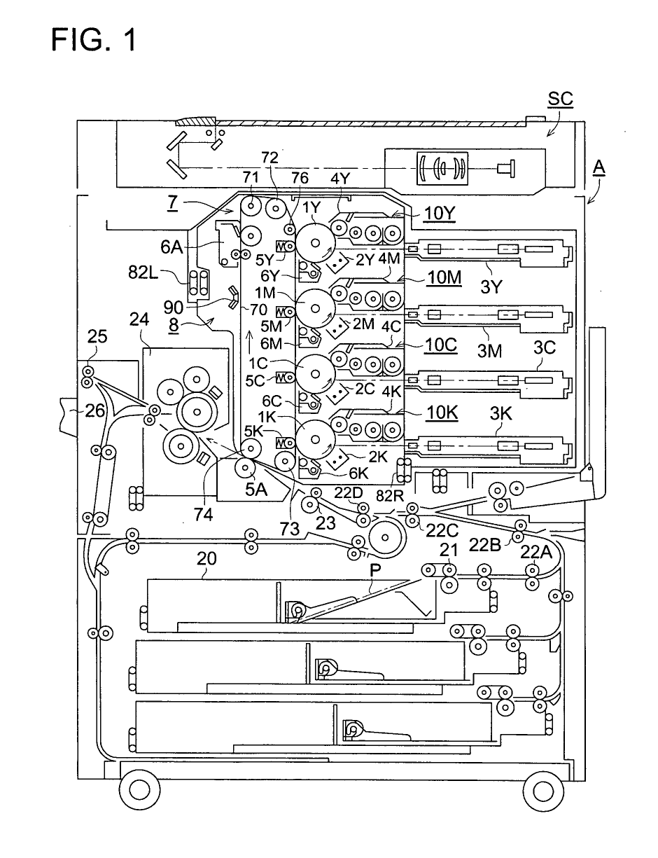

FIG. 1 is a cross-sectional construction diagram of a color image forming apparatus, showing an embodiment of the invention;
This color image forming apparatus is called a tandem type color image forming apparatus and is comprised of a set of plurality of image forming sections 10Y, 10DM, 10C, and 10K, endless-belt shape intermediate transfer unit 7, sheet convey device 21, and fixing device 24.

Document image reading device SC is arranged on body A of the image forming apparatus.

The image forming section 10Y that forms yellow images is comprised of charging device 2Y, exposure device 3Y, developing device 4Y, primary transfer roller 5Y as primary transfer means, and cleaning device 6Y, which are arranged around drum shape photoreceptor 1Y as a first image carrier.

The image forming section 10M that forms magenta images is comprised of drum shape photoreceptor 1M as a first image carrier, charging device 2M, exposure device 3M, developing device 4M, primary transfer roller 5M as primary transfer means, and cleaning device 6M. The image forming section 10C that forms cyan images is comprised of drum shape photoreceptor 1C as a first image carrier, charging device 2C, exposure device 3C, developing device 4C, primary transfer roller 5C as primary transfer means, and cleaning device 6C. The image forming section 10K that forms black images is comprised of drum shape photoreceptor 1K as a first image carrier, charging device 2K, exposure device 3K, developing device 4K, primary transfer roller 5K as primary transfer means, and cleaning device 6K.

The endless-belt shape intermediate transfer unit 7 is windingly circulated by a plurality of rollers and has second endless-belt shaped intermediate transfer member 70, as a second image carrier, that is circulatively supported, semiconductive, and in an endless-belt shape.

Images in respective colors formed by the image forming sections 10Y, 10DM, 10C, and 10K are sequentially transferred onto the rotating endless-belt shape intermediate transfer member 70 by the primary transfer rollers 5Y, 5M, 5C, and 5K as primary transfer means so that a composite color image is formed. Sheet P as a recording medium (a support to bear a fixed final image, such as a regular paper, a transparent sheet) received in sheet feeding cassette 20 is fed by sheet feeding device 21, conveyed to secondary transfer roller 5A as secondary transfer means through a plurality of intermediate rollers 22A, 22B, 22C, 22D, and registration roller 23, and then, the color image is secondarily transferred onto the sheet P in one-shot. The sheet P on which the color image has been transferred is fixed by fixing device 24, sandwiched by exit roller 25, and mounted on exit tray 26 outside the machine.

On the other hand, after the color image has been transferred to the sheet P by the secondary transfer roller 5A as the secondary transfer means, the endless-belt type intermediate transfer member 70, from which the sheet P has self-striped, is removed of residual toner by cleaning device 60A.

During the image forming processing, the primary transfer roller 5K is all the time pressed against the photoreceptor 1K. The other primary transfer rollers 5Y, 5M, and 5C are pressed against the respective photoreceptors 1Y, 1M, and 1C only when the respective color images are formed.

The secondary roller 5A is pressed against the endless-belt shape intermediate transfer member 70 in contact therewith only when the sheet P passes through between them and the secondary transfer is carried out.

Housing 8 can be drawn out from the apparatus body A, guided by supporting rails 82L and 82R.

In the housing 8, there are arranged the image forming sections 10Y, 10M, 10C, 10K, and the endless-belt shape intermediate transfer unit 7.

The image forming sections 10Y, 10M, 10C, and 10K are disposed vertically in alignment. The endless-belt shape intermediate transfer unit 7 is disposed on the left side, in the figure, of the photoreceptors 1Y, 1M, 1C, and 1K. The endless-belt shape intermediate transfer unit 7 is comprised of the endless-belt shape intermediate transfer member 70 which is circulative and windingly rotated by the rollers 71, 72, 73, and 74, the primary transfer rollers 5Y, 5M, 5C, 5K, and the cleaning device 6A.

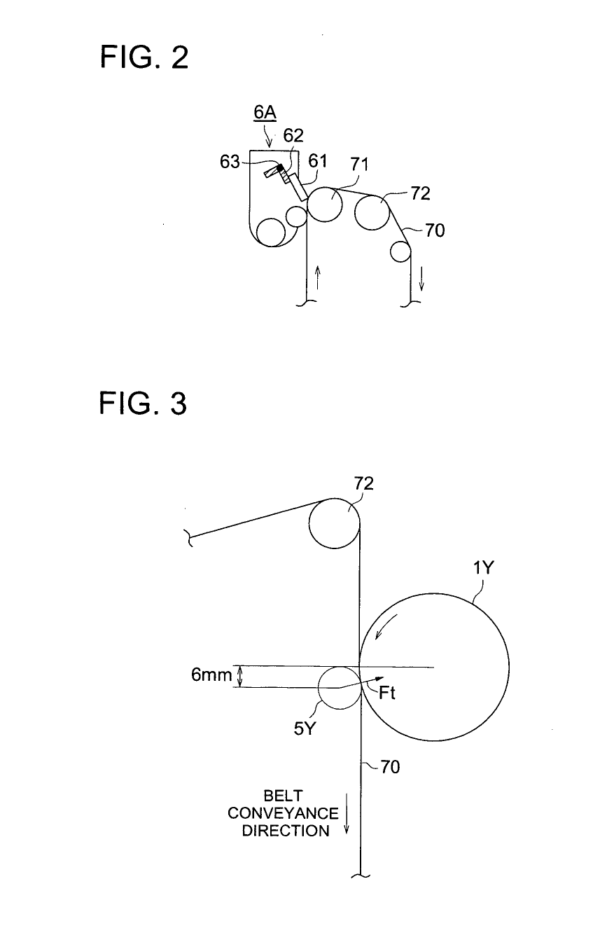

FIG. 2 shows an example of a cleaning device of an intermediate transfer member;
The cleaning device 6A of the intermediate transfer member is constructed by blade 61 fitted to bracket 62 that is controlled rotatively around supporting shaft 63, as shown in FIG. 2, and the pressing force of the blade applied to the roller 71 can be adjusted by varying a spring load or gravity load.

By drawing the housing 8, the image forming sections 10Y, 10M, 10C, and 10K, and the endless-belt shape intermediate transfer unit 7 can be integratedly drawn out from the body A.

The supporting rail 82L on the left side, in the figure, of the housing 8 is disposed at the left of the endless-belt shape intermediate transfer member 70 and above the fixing device 24. The supporting rail 82R on the right side, in the figure, of the housing 8 is disposed in the vicinity below the developing device 4K at the bottom part. The supporting rail 82R is disposed at a position where the developing device 4Y, 4M, 4C, and 4K are not obstructed from attaching to and detaching from the housing 8.

The right parts, in the figure, of the photoreceptor 1Y, 1M, 1C, and 1K are surrounded by the respective developing devices 4Y, 4M, 4C, and 4K; the bottom parts, in the figure, thereof are surrounded by the respective charging devices 2Y, 2M, 2C, and 2K, and the respective cleaning devices 6Y, 6M, 6C, and 6K; and the left parts, in the figure, thereof are surrounded by the endless-belt shape intermediate transfer member 70.

A combination of a photoreceptor, a cleaning device, charging device, and the like, forms one photoreceptor unit, and a combination of a developing device, a toner supply device, and the like, forms one developing unit.

FIG. 3 is an arrangement diagram showing the position relationship between a photoreceptor, the endless-belt shape intermediate transfer member, and a primary transfer roller. The primary transfer roller 5Y, 5M, 5C, and 5K are pressed against the respective photoreceptors 1Y, 1M, 1C, and 1K from the rear side of the endless-belt shape intermediate transfer member 70 as the intermediate transfer member, wherein, as shown in the arrangement diagram of FIG. 3, the primary transfer rollers 5Y, 5M, 5C, and 5K are pressed against the respective photoreceptors 1Y, 1M, 1C, and 1K, at positions downstream, with respect to the direction of the rotation of the photoreceptors, from the respective points of contact between the endless-belt shape intermediate transfer member 70, as the intermediate transfer member, and the photoreceptors 1Y, 1M, 1C, and 1K, at which points the endless-belt shape intermediate transfer member 70 contacts with the respective photoreceptors 1Y, 1M, 1C, and 1K while the primary transfer rollers 5Y, 5M, 5C, and 5K are not pressed against the respective photoreceptors 1Y, 1M, 1C, and 1K. When the primary transfer rollers 5Y, 5M, 5C, and 5K are pressed against the photoreceptors 1Y, 1M, 1C, and 1K, the endless-belt shape intermediate transfer member 70, as an intermediate transfer member, is curved along the respective circumferences of the photoreceptor 1Y, 1M, 1C, and 1K, and the primary transfer rollers 5Y, 5M, 5C, and 5K are disposed at the most downstream side of the respective regions in which the photoreceptors contact with the endless-belt shape intermediate transfer member 70.

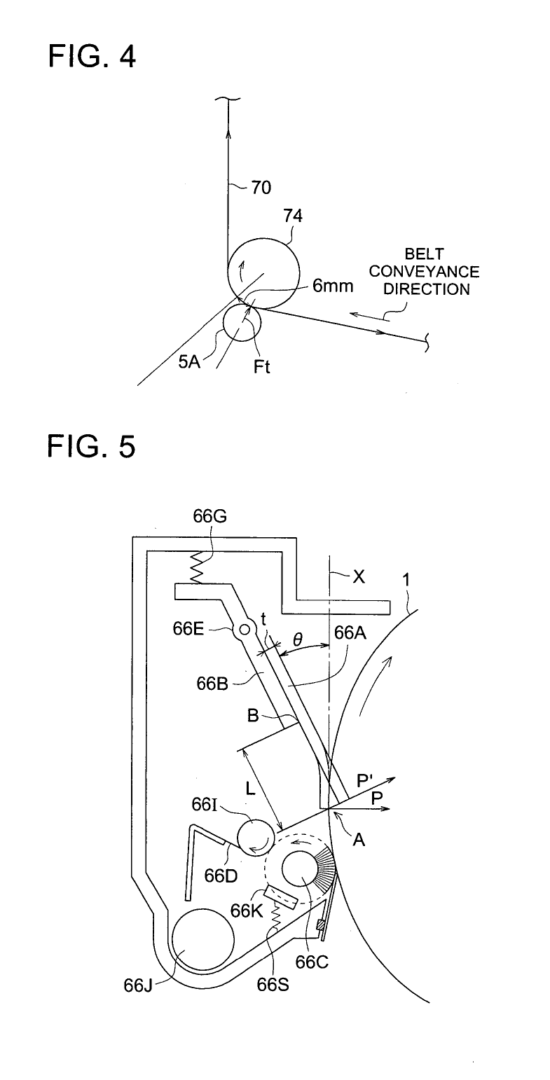

FIG. 4 is an arrangement diagram showing the position relationship between a backup roller, the endless-belt shape intermediate transfer member, and the secondary transfer roller. It is desirable, as shown in the arrangement diagram in FIG. 4, that the secondary transfer roller 5A is positioned upstream, with respect to the direction of the rotation of the backup roller 74, from the center of a contact region between the endless-belt shape intermediate transfer member 70, as the intermediate transfer member, and the backup roller 74, in which region the endless-belt shape intermediate transfer member 70 and the backup roller 74 contact with each other while the intermediate transfer member 70 is not pressed by the secondary transfer roller 5A.

For the intermediate transfer member, used is a high molecular film of polyimide, polycarbonate, PVdF, or the like, or, synthetic rubber such as silicon rubber, fluorine rubber, added with conductive filler to be made conductive, wherein either a drum-shaped type or a belt-shaped type is applicable, but a belt-shaped type is preferable in viewpoint of degree of freedom of apparatus design.

Further, preferably, the surface of the intermediate transfer member is suitably made rough.

Ten point surface roughness Rz of the intermediate transfer member is made in the range from 0.5 to 2 μm so that the surface energy lowering agent provided on the photoreceptor is taken onto the surface of the intermediate transfer member to reduce the adhering force of toner on the intermediate transfer member, which makes it easy to improve the transfer ratio of toner in the secondary transfer from the intermediate transfer member to a recording sheet.

In this situation, the effect tends to be greater, if ten point surface roughness Rz of the intermediate transfer member is greater than that of the photoreceptor.

Although it has been described on an image forming apparatus employing an intermediate transfer member, referring to FIGS. 1 to 4, the invention may be applied to an image forming apparatus that directly transfers a toner image on a photoreceptor without employing an intermediate transfer member.

As a method for providing a surface energy lowering agent on the surface of an electrophotographic photoreceptor, there is a method in which the surface energy lowering agent is mixed into a developer, and provided to a photoreceptor through the developer, but preferably, a different method is employed. This is because, in the case of mixing a surface energy lowering agent into a developer, this mixing affects the developing characteristics of the toner including the charging characteristics and the flow characteristics, which makes it difficult to achieve an enough mixing amount, and to attain prevention effect of character blurring.

As a method for providing a surface energy lowering agent, it is preferable that the image forming apparatus is provided therein with agent providing means for providing a surface energy lowering agent on the surface of the electrophotographic photoreceptor, and the lowering agent is provided by this means. The agent supply device can be installed at any suitable position around the photoreceptor, however, to utilize a installation space, the agent supply device may be installed making use of a part of the charging device, developing device, or the cleaning device illustrated in FIG. 1. In the following, an example of using the cleaning device also as the agent supply device will be described.

FIG. 5 is a construction diagram of the cleaning device installed at the photoreceptor. This cleaning device is used as a cleaning device of 6Y, 6M, 6C, 6K, and the like, in FIG. 1. Cleaning blade 66A in FIG. 5 is fitted to supporting member 66B. As the material of the cleaning blade, a rubber elastic body is employed. Specifically, for the material, there are known urethane rubber, silicone rubber, fluorine-containing rubber, chloropyrene caoutchouc, butadiene rubber, wherein urethane rubber is particularly preferable because of excellent friction characteristic compared with other rubbers.

On the other hand, Supporting member 66B is constructed by a plate shape metal material or plastic material. As a metal material, a stainless steel plate, aluminum plate, or an earthquake resistant steel plate is preferable.

The tip of the cleaning blade that is pressed against the surface of the photoreceptor in contact therewith is preferably pressed in the state that a load is applied in the direction (counter direction) opposite to the rotation of the photoreceptor. As shown in FIG. 5, the tip of the cleaning blade preferably forms a pressure contact plane when it contacts with the photoreceptor with pressure.

Preferable values of contact load P and contact angle θ are respectively P=5 to 40 N/m and θ=5 to 35 degrees.

The contact load P is a vector value, in the normal direction, of press load P′ during when cleaning blade 66A is in press contact with photoreceptor drum 1.

The contact angle θ is an angle between tangent X of the photoreceptor at contact point A and the blade (shown by a dotted line) having not yet been displaced. Numeral 66E represents a rotation shaft that allows the supporting member to rotate, and 66G represents a load spring.

Free length L of the cleaning blade represents, as shown in FIG. 5, the distance between the position of edge B of the supporting member 66B and the tip point of the blade having not yet been displaced. A preferable value of the free length L is in the range from 6 to 15 mm. Thickness t of the cleaning blade is preferably in the range from 0.5 to 10 mm. The thickness of the cleaning blade herein is in the octagonal direction with respect to a surface adhering to the supporting member 66B.

Brush roll 66C is employed as the cleaning device in FIG. 5 which also serves as the agent supply device.

The brush roll has functions of removing toner adhering to the photoreceptor 1 and recovering the toner removed by the cleaning blade 66A as well as a function as an agent supply device for supply of surface energy lowering agent to the photoreceptor. That is, the brush roll contacts with the photoreceptor 1, rotates in the same direction with the rotation of the photoreceptor at a contact part thereof, removes toner and paper particles on the photoreceptor, conveys toner removed by the cleaning blade 66A, and recovers the removed toner and paper particles to conveying screw 66J.

Regarding the path herein, it is preferable that flicker 66I as removing means is contacted with the brush roll 66C, thereby removing the removed such as the toner which has been transferred from the photoreceptor 1 to the brush roll 66C.

Further, the toner deposited to the flicker is removed by scraper 66D and recovered into the conveying screw 66J. The recovered toner is taken out outside as waste, or conveyed to a developing vessel through a recycle pipe (not shown) for recycling toner to be reused. As a material of the flicker 66I, metal pipes of stainless steel, aluminum, etc. are preferably used. As the scraper 66D, it is preferable that an elastic plate such as phosphor-bronze plate, polyethylene terephthalate board, polycarbonate plate is employed, and the tip thereof is contacted with the flicker by a counter method in which the tip forms an acute angle with respect to the rotation direction of the flicker.

Surface energy lowering agent (solid material of zinc stearate) 66K is pressed by spring load 66S to be fitted to the brush roll, and the brush rubs the surface energy lowering agent while rotating to supply the surface energy lowering agent to the surface of the photoreceptor.

As the brush roll 66C, a conductive or semiconductive brush roll is employed.

An arbitrary material can be used as the material of the brush of the brash roll, however, a fiber forming high molecular polymer having a high dielectric constant is preferable. As such a high molecular polymer, for example, rayon, nylon, polycarbonate, polyester, a methacrylic acid resin, acryl resin, polyvinylchloride, polyvinylidene chloride, polypropylene, polystyrene, polyvinyl acetate, styrene-butadiene copolymer, vinylidene chloride-acrylonitrile copolymer, chloroethylene-acetic acid vinyl copolymer, chloroethylene-vinyl acetate-maleic anhydride copolymer, silicone resin, silicone-alkyd resin, phenol-formaldehyde resin, styrene-alkyd resin, polyvinylacetal (for example, polyvinylbutyral) may be usable. These binder resin can be used solely or in a mixture of each other in two or more high molecular polymers.

Preferably, rayon, nylon, polyester, acryl resin, polypropylene may be usable.

As the brush, a conductive or semiconductive brush is employed, wherein the brush is prepared by providing a low resistance material such as carbon into a material of the brush and adjusting the specific resistance of the material of the brush to an arbitrary value.

The specific resistance of a brush bristle of the brush roll is preferably in the range from 10¹ to 10⁶ Ωcm when measured in the state that a voltage of 500 volts is applied to both ends of a piece of brush bristle with a length of 10 cm at a normal temperature and humidity (temperature 26° C., humidity 50%).

The brush roll is preferably comprised of a stem of stainless steel or the like and conductive or semiconductive brush bristles having a specific resistance in the range from 10¹ to 10⁶ Ωcm. In this range, banding or the like due to electric discharge and cleaning defects hardly occur.

A brush bristle for the brush roll preferably has a thickness in the range from 5 to 20 denier. In this range, surface deposits can be removed well by an enough rubbing force, and further, the surface of the photoreceptor is not damaged much, which achieves a long life of the photoreceptor.

The value in “denier” herein is the value of mass of a 9000 m long brush bristle (fiber) measured in grams, the brush bristle constructing the brush.

The density of the brush bristles of the brush is in the range from 4.5×10²/cm² to 2.0×10⁴/cm² (number of brush bristles per cm²). In this range, it is possible to uniformly remove deposits, prevent the photoreceptor from abrasion, and prevent image defects such as fogging due to drop in sensitivity and black streaks due to scratches.

The depth of piercing of the brush roll into the photoreceptor is preferably set within the range 0.4 to 1.5 mm, more preferably 0.5 to 1.2 mm. This depth of piercing is equivalent to the load caused by a relative motion between the drum of the photoreceptor and the brush roll and applied to the brush. This load corresponds to the rubbing force applied by the brush, in a viewpoint of the photoreceptor.

This depth of piercing is defined by a length of piercing into the photoreceptor with an assumption that a brush bristle goes linearly inside the photoreceptor without curving on the surface of the photoreceptor when the brush contacts with the photoreceptor.

Since the rubbing force of the brush on the surface of the photoreceptor being provided with a surface energy lowering agent is weak, if the depth of piercing of the brush roll into the photoreceptor is set within the range from 0.4 to 1.5 mm, it is possible to reduce filming of paper particles and the like onto the surface of the photoreceptor, prevent defects such as irregularities on the image, and prevent occurrence of fogging due to drop in sensitivity, scratches on the surface of the photoreceptor, and streaking defects on the image.

As the stem of a roll part to be used as a brush roll, metals such as stainless steel and aluminum, paper, plastics are mostly used, but not limited to these.

The brush roll is provided with a brush through a sticking layer on the surface of a cylindrical stem. This situation is preferable.

The brush roll preferably rotates such that a contact part thereof moves in the same direction as that of the motion of the surface of the photoreceptor. If the contact part moves in the opposite direction, and there is excessive toner on the surface of the photoreceptor, toner removed by the brush roll may spill out and dirty the recording sheet and the apparatus.

In the motion of the photoreceptor and the brush roll in the same direction as described above, the surface velocity ratio between them is in the range from 1:1 to 1:2. This situation is preferable. If the rotation speed of the brush roll is smaller than that of the photoreceptor, the toner removal performance of the brush roll is reduced, thus cleaning defects easily occur, and if the rotation speed of the brush roll is greater than that of the photoreceptor, the toner removal performance is excessive to cause blade bounding or curving.

In an image forming apparatus, as stated above, provided with an intermediate transfer member, it is preferable that agent providing means for providing a surface energy lowering agent with a water content ratio of 5.0 weight percent or lower on the surface of an electrophotographic photoreceptor is in contact with the surface of the electrophotographic photoreceptor.

Here, a surface energy lowering agent is a substance that adheres to the surface of a photoreceptor and lowers the surface energy of the photoreceptor, and more specifically, a material that increases the contact angle (contact angle with respect to deionized water) of the surface of the photoreceptor in a degree equal to or greater than 1 degree by adhering to the surface.

Measurement of Contact Angle

The contact angle of the surface of the photoreceptor is measured with respect to deionized water with a contact angle meter (model CA-DT•A manufactured by Kyowa Interface Science Co., Ltd.) in an environment of 30° C. and RH 80%.

As to whether or not the surface energy is lowered can be determined in such a manner that the contact angle of the photoreceptor is measured, prior to providing of the surface energy lowering agent, under the same conditions; then, the photoreceptor after having being provided with the surface energy lowering agent is left standing for 24 hours under the environment of 30° C. and 80% RH; and thereafter, the contact angle is measured under the same environment, thus finding the difference between the measured values.

Incidentally, the contact angle is defined by the average of contact angles in the central part of the image forming section of the photoreceptor.

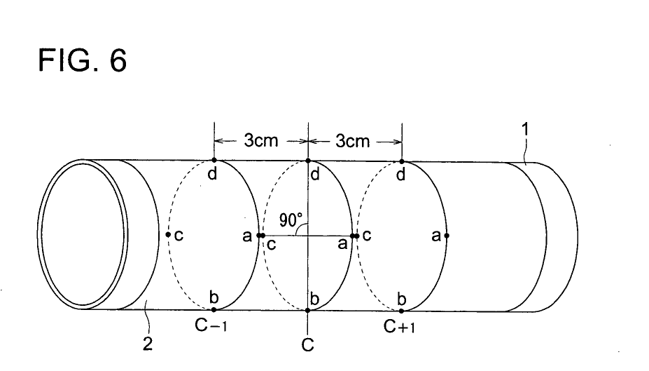

That is, the contact angle on the central portion of the image forming section, explained referring to FIG. 6, are at respective four points on cross-sections at the central position C, position C−1, and position C+1, wherein C−1 and C+1 are 3 cm distant from C, and the four points on each cross-section are on lines orthogonal to each other.

The surface energy lowering agent is provided herein such that the surface of the photoreceptor is uniformly covered.

To do so, there is a method, for example, in which a surface energy lowering agent is provided by a brush roll that rotates in the same direction with a photoreceptor.

In this case, a uniform layer of the surface energy lowering agent is formed in such a manner that enough surface energy lowering agent is provided, and the photoreceptor is rotated at least 100 times, and under the conditions: the depth of piercing of the brush roll is set in the range from 0.4 to 1.5 mm approximately; the density of the brush bristles of the brush is set in the range from 4.5×10² to 2.0×10⁴/cm² (number of brush bristles per cm²); and, in the case where the photoreceptor and the brush roll move in the same direction, the surface velocity ratio therebetween is set in the range from 1:1.1 to 1:2.

Further, as far as the measurement principle is the same, other measurement device can be used.

Incidentally, as the surface energy lowering agent, although fatty acid metal salt or fluororesin can be used, these materials tend to have a high water content ratio under high temperature and humidity conditions due to hydrophilic groups and impure components in the materials. With a large amount of the water content, it is difficult to uniformly extend the surface energy lowering agent on the surface of the photoreceptor. Therefore, the water content ration of the surface energy lowering agent is to be 5.0 weight percent or lower under the conditions with a high temperature of 30° C. and a high humidity of 80% RH. This situation is preferable.

As a surface energy lowering agent, it is not limited to materials of fatty acid metal salt or a fluororesin, and any material can be applied as long as the material increases the contact angle (contact angle with respect to deionized water) of the surface of an electrophotographic photoreceptor in a degree equal to or greater than one degree.

As a surface energy lowering agent, fatty acid metal salt is most preferable because of extendibility on the surface of a photoreceptor and performance of forming a uniform layer. As for the fatty acid metal salt, saturated or unsaturated fatty acid metal salt having carbon number of 10 or more is preferable. For example, aluminum stearate, stearic acid indium, stearic acid gallium, zinc stearate, lithium stearate, magnesium stearate, sodium stearate, pal thymine acid aluminium, aluminium oleate may be usable. More preferably, metal stearate may be usable.

Among the above fatty acid metal salt, fatty acid metal salt with a particularly high outflow rate measured by a flow tester is highly cleavage and capable of effectively forming a layer of fatty acid metal salt on the surface of a photoreceptor. The outflow rate is preferably in the range from 1×10⁻⁷ to 1×10⁻¹, and most preferably from 5×10⁻⁴ to 1×10⁻². The outflow rate was measured employing Shimadzu Flowtester “CFT-500” (manufactured by Shimadzu Corporation).

A fluorine resin powder such as polytetrafluoroethylene, polyvinylidene fluoride, are preferable for an other example of the solid material.

It may be desirable that these solid material pressures is used in a plate shape or a bar shape by being applied with pressure as necessary.

On the other hand, measurement of the water content ratio of the surface energy lowering agent can be performed after puting the material into a laboratory dish and leaving the material for 24 hours at a temperature of 30° C. and RH 80% with Karl Fischer Moisture Titrator (model MKA-3p manufactured by Kyoto Electronics).

Adjustment of the water content ratio of the surface energy lowering agent to be lower than 5.0 weight % can be achieved by control of hydrophilic components and impurities in the material such as refining, hydrophobic processing, and decreasing of water content amount under a high temperature and humidity (30° C. and RH 80%) as well as mixing of water content adjusting agent, high temperature drying, and the like. The water content ratio is preferably 0.01 to 5.0 wt %, and further preferably in the range from 0.05 to 3.0 wt %.

Within the above range, an copy operation may not be influenced by an enbironmental fluctuation due to a raise in temperature, in particular, humidity at a location on the image carring member so that image racking and character scattering hardly occur.

The ten point surface roughness Rz on the photoreceptore is 0.05 to 4.0 μm. This condition may be preferable, more preferably, it is 0.05 to 2.5 micron m.

By setting the ten point surface roughness of the photoreceptor within the above range, the surface energy lowering agent is supplied onto the surface of the photoreceptor by the agent supply device uniformly, and extended on the surface of the photoreceptor uniformly to form a layer, which allows the surface energy of the photoreceptor to decrease uniformly so that occurrence of hollow defects and character blurring, and degradation of sharpness are prevented.

Ten point surface roughness of the photoreceptor Rz (Definition and Measuring method of ten point surface roughness Rz)

Rz means a value for a reference length of 0.25 mm described in JISB0601-1982. That is the difference between the average height of the highest five peaks and the average depth of the lowest five valleys between a distance of the reference length 0.25 mm.

In an embodiment described later, ten point surface roughness Rz was measured with a surface roughness meter (Surfcorder SE-30H manufactured by Kosaka Laboratory Ltd.). However, any other measuring device can be employed as long as it obtains the same result within an error range.

Adjustment of the ten point surface roughness Rz of the photoreceptor to be in the range of 0.05 to 4.0 μm can be achieved by adjusting the surface roughness of a support that constructs the photoreceptor and the surface roughness of the surface layer of the photoreceptor.

Particularly, the surface roughness can be effectively adjusted by providing a layer constructing the surface layer of the photoreceptor with various kinds of particles.

Ten point surface roughness Rz of the photoreceptor can be effectively controlled to be within the range of 0.05 to 4.0 μm by giving roughness to the surface of the conductive support that constructs the photoreceptor to a proper degree.

For material of electroconductivity support, metals material such as aluminum, copper, brass, steel, stainless steel, in addition, plastic material may be mainly used, and these material may be used to be shaped in a belt or a drum.

Particularly, aluminum is preferably employed because of advantages in cost and manufacturability, and in usual cases, extrusion formed or drawing formed aluminum base pipes in a thin cylinder shape are widely used.

Ten point surface roughness Rz of the conductive support is preferably greater than 0.1 μm and not greater than 6.0 μm, and more preferably within the range from 0.2 μm to 5.0 μm. The roughness of the surface can be adjusted by coating an intermediate layer and a photoreceiving layer, described later, on the support having such a surface roughness.

As stated above, the surface of the support can be made rough by cutting the surface of the support with a cutting tool or the like, sandblasting in which micro particles are collided with the surface of the support, processing with an ice particle cleaning device disclosed in TOKKAI No. H04-204538, or honing processing disclosed in TOKKAI No. H09-236937. Further, the surface of the support can be made rough by anodic oxidation method, alumite treatment, buffing processing, laser abrasion method described in TOKKAI No. H04-233546, a method using an abrasive tape described in TOKKAI No. H08-1502, or roller burnishing described in TOKKAI NO. H08-1510, or the like. However, methods for making the surface of the support rough are not limited to these.

As another method of making the surface of the photoreceptor rough, there is also a method providing particles with a number average particle diameter within a range of 0.05 to 8 μm into a surface layer of the photoreceptor. Regarding particles to be provided, it is possible to adjust ten point surface roughness of the photoreceptor to be within the above range by dispersely providing the surface layer of the photoreceptor with inorganic micro particles having been subjected to hydrophobic treatment as described in TOKKAI No. H08-248663, for example. Inorganic particles can be made hydrophobic by employing a method using a hydrophobic treatment agent such as titanate coupling agent, silane coupling agent, high molecule fatty acid or metal salt of high molecule fatty acid.

As organic particles for the above described particles, particles of polyacrylics, polymethacrylate, polymethyl methacrylate, polyethylene, polypropylene, polyvinylidene fluoride may be applied.

As inorganic particles, particles such as silica, titanic oxide, alumina, barium titanate, calcium titanate, strontium titanate, zinc oxide, magnesium oxide, zirconia, barium sulfate, barium carbonate, calcium carbonate, silicon carbide, silicon nitride, chromium oxide, red ocher can be applied.

The inorganic particles described above are preferably subjected to hydrophobic processing. This hydrophobic processing can be performed by reacting inorganic particles with hydrophobic treatment agent at a high temperature. The hydrophobic treatment agent is not particularly limited, and for example, silane coupling agent such as hexamethyldisilazane, dimethyldichlorosilane, decyl silane, dialkyl dihalogen silane, trialkyl halogenated silane, and alkyl trihalogenated silane or dimethyl silicone oil may be usable. The amount of the hydrophobic treatment agent depends on the kind of the particles and the like, and cannot necessarily be specified, but usually, the greater the amount, the higher the hydrophobic degree. Further, it is effective that hygroscopic substances are removed by reprecipitation, heat treatment, or the like.

The number average particle diameter of micro particles and the like is preferably in the range of 5 nm to 8 μm, and further preferably 10 nm to 6 μm. Incidentally, the number average particle diameter is obtained in such a way that: the particles are magnified 2000 times by observation with a transfer type electronic microscope; particles in a quantity of 100 are observed at random as primary particles; and thus, a measured value is determined by image analysis as an average diameter in Feret direction.

Next, a photoreceptor will be described. A photoreceptor is an electrophotographic photoreceptor to be used for electrophotographic image forming, and particularly, is an organic electrophotographic photoreceptors (organic photoreceptor). Organic photoreceptors are electrophotographic photoreceptors that are provided, in an organic compound thereof, with at least one of a charge generating function and a charge transporting function, which is essential for an electrophotographic photoreceptor, and include photoreceptors made of a known organic charge generating material or organic charge transporting material, photoreceptors made of a high molecular complex with a charge generating function and a charge transporting function, and all other known organic electrophotographic photoreceptors.

The configuration of an organic photoreceptor will be described below.

Conductive Support

As a conductive support may have either a sheet shape or a cylindrical shape, wherein cylindrical conductive support is preferable for designing an image forming apparatus in a small size.

An cylindrical conductive support is a cylindrical support which is necessary for endless forming of images with rotation, and is preferably a conductive support having a circularity not greater than 0.1 mm and a run-out not greater than 0.1 mm. If the circularity or the run-out exceeds this range, it is difficult to achieve satisfactory image forming.

A metal drum of aluminium or nickel, a plastic drum deposited with aluminium, tin oxide, which deposited oxidation indium oxide or a paper plastic drum coated with an electroconductivity material can be employed for material of electroconductivity. In a conductive support, the specific resistance is preferably equal to or smaller than 10³ Ωcm at a normal temperature.

Intermediate Layer

It is also possible to provide an intermediate layer having a function of improving the adhesibility to the photosensitive layer and a function as an electrical barrier, between the conductive support and the photoreceptive layer. The layer thickness of an intermediate layer using a curable metal resin is preferably in the range of 0.1 to 5 μm.

Photoreceptive Layer

The photoreceptive layer of a photoreceptor may have a mono-layer structure having a charge generating function and a charge transporting function in a single layer which is disposed on the intermediate layer. However, it is more preferable that the photoreceptive layer has a structure in which the functions thereof are separately provided in a charge generating layer (CGL) and a charge transporting layer (CTL) thereof. With a structure of a photoreceptor having functions in separate layers, increase in residual electric potential due to repeated use can be controlled to be small, and other electric photographic characteristics can be easily controlled to suit purposes. A photoreceptor for negative charging preferably has a structure with a charge generating layer (CGL) disposed on an intermediate layer and a charge transporting layer (CTL) on the CGL. In the case of a photoreceptor for positive charging, the order of the above layer structure is reversed from that in the case of a photoreceptor for negative charging. The most preferable structure of a photoreceptor is that of a photoreceptor for negative charging, in which functions are provided in separate layers, as described above.

Preparation of a photoreceptive layer of a photoreceptor for negative charging with functions in separate layers will be described below.

Charge Generating Layer

A charge generating layer contains a charge generating material (CGM).

In addition, the charge generating layer may contain a binder resin and other additives as necessary.

As the charge generating material (CGM), a known charge generating material (CGM) can be used. For example, phthalocyanine pigment, azo pigment, a perylene pigment, an asrhenium pigment can be applied. Among these, CGMs which can minimize increase in residual electrical potential due to repeated use have a cubic electric potential structure which allows a stable cohesive structure between a plurality of molecules, and are concretely CGMs such as phthalocyanine pigment and perylene pigment having a special crystal structure. For example, CGMs such as titanylphthalocyanine having a maximum peak of Bragg angle 2θ for Cu—Kα radiation at 27.2 degrees and benzimidazole perylene having a maximum peak of the same at 12.4 degrees, do not degrade with repeated use and can reduce increase in residual electric potential.

In case of using a binder as a dispersing medium of a CGM in the charge generating layer, a known resin can be employed for the binder, and the most preferable resins are butyral resin, silicone resin, silicone modification butyral resin, phenoxy resin. The ratio between the binder resin and the charge generating material is preferably binder resin 100 weight part for charge generating material 20 to 600 weight part. Increase in residual electric potential with repeated use can be minimized by using these resins.

The layer thickness of the charge generating layer is preferably in the range of 0.01 to 2 μm.

Charge Transporting Layer

A charge transporting layer contains a charge transporting material (CTM) and a binder resin for dispersing the CTM and forming a layer. In addition, the charge transporting layer may contain additives such as an antioxidant agent as necessary.

As a charge transporting material (CTM), a known charge transporting material (CTM) can be used. For example, triphenylamines, hydrazones, styryl compound, benzidine compound, butadiene compound can be applied. These charge transporting materials are usually dissolved in a proper binder resin to form a layer. Among these, CTMs which can minimize increase in residual electric potential due to repeated use have a high mobility and a characteristic that the ionization potential difference from that of a CGM to be combined is not greater than 0.5 eV, and preferably not greater than 0.25 eV.

An ionization potential of CGM and CTM can be measured with a surface analysis apparatus AC-1 (a product made in Riken Keiki company).

As a resin used for the charge transporting layer (CTL), for example, polystyrene, acryl resin, methacrylic resin, vinyl chloride resin, vinyl acetate resin, polyvinyl butyral resin, epoxide resin, polyurethane resin, phenol resin, polyester resin, alkyd resin, polycarbonate resin, silicone resin, melamine resin range and copolymer resin including more than repetition units of two resins among these resins may be usable. Further, other than these insulation-related resin, high polymer organic semiconductor such as poly —N— vinyl carbazole may be usable.

The most preferred material is polycarbonate resin as a binder of these CTLs. Further it is preferable that film thickness of the charge transporting layer is 10-40 μm.

Protective Layer

As a protective layer of photoreceptor, various kinds of resin layer can be provided. In particular, by providing a cross linking type resin layer, an organic photoreceptor having strong machinery strength can be obtained.

Hereafter, the toner preferably used is explained.

Preferable particle size distribution of toner particles is one which is obtained when particles are monodispersed or nearly monodispersed. It is preferable that ratio (Dv50/Dp50) is from 1 to 1.15, wherein (Dv50) is the 50 percent volume particle diameter and (Dp50) is the 50 percent number particle diameter. The ratio is more preferably from 1 to 1.13.

Ratio (Dv75/Dp75) from 1 to 1.2 is preferable, wherein Dv75 is the cumulative 75 percent volume particle diameter from the maximum diameter of the colored particle and Dp75 is the cumulative 75 percent number particle diameter. By the ratio of 1 to 1.2, a ratio of presence of smaller particle components is reduced, and it causes decrease of weakly charged components, as well as difficulty to generate toner having reverse polarity or to generate excessively charged components. As a result, it tends to obtain excellent transfer property, cleaning property as well as high-resolution image.

It is preferable the proportion of colored particles, having a particle diameter of at most 0.7× (Dp50), is less than or equal to 10 percent by number.

When the ratio is not more than 10% by number, a ratio of presence of smaller particle components is decreased, and it causes that decrease of weakly charged components, as well as difficulty to generate toner having reverse polarity or to generate excessively charged components.

As a result, it tends to obtain excellent transfer property, cleaning property as well as high-resolution image.

In a plurality of color toners employed in a color image forming method, difference between the maximum 50 percent volume particle diameter and the minimum 50 percent volume particle diameter of each toners may be less than or equal to 1 μm. During transfer of toners which are superimposed with each color, when the particle size distribution is not more than 1 μm each other, transferability make smooth each other. As a result, high image quality may be obtained. In addition, difference between the maximum cumulative 75 percent volume particle diameter from the largest particle of each color toner and the minimum cumulative 75 percent volume particle diameter may be less than or equal to 1 μm in the same reason above.

The 50 percent volume particle diameter (Dv50) is preferably from 2 to 8 μm, and is more preferably from 3 to 7 μm. By adjusting said diameter to the above range, it is possible to enhance high resolution. By adjusting Dv50/Dp50 and Dv75/Dp75 to the specified values as well as by adjusting Dv50 to such a value, it is possible to reduce the proportion of toner particles having a minute particle diameter, even though said toner contains particles having a relatively small diameter, and it is also possible to provide toner capable of forming consistent quality images over an extended period of time.

The cumulative 75 percent volume particle diameter (Dv75) or the cumulative 75 number particle diameter from the largest particle, as described herein, refers to the volume particle diameter or the number particle diameter at the position of the particle size distribution which shows 75 percent of the cumulative frequency with respect to the sum of the volume or the sum of the number from the largest particle.

It is possible to determine 50 percent volume particle diameter (Dv50), 50 percent number particle diameter (Dp50), cumulative 75 percent volume particle diameter (Dv75), and cumulative 75 percent number particle diameter (Dp75), employing a Coulter Counter Type TAII or a Coulter Multisizer (both are manufactured by Coulter Inc.).

The toner having the proportion of colored particles having a diameter of less than or equal to 0.7× (Dp50) being 10 percent by number is preferable. It is possible to determine the amount of said minute particle toner, employing an Electrophoretic Light Scattering Spectrophotometer ELS-800, manufactured by Otsuka Electronics Co., Ltd.

In the technical field the present invention is involved in which electrostatic latent images are visualized employing dry system development, as an electrostatic image developing toner employed are those which are prepared by adding external additives to colored particles containing at least colorants and resins. However, as long as specifically there occurs no problems, it is generally described that colored particles are not differentiated from the electrostatic latent image developing toner. The particle diameter and particle size distribution of the colored particles result in the same measurement values as the electrostatic latent image developing toner. It may be preferable that number mean particle size of toner are 3.0-8.5 μm.

The particle diameter of external agents is in an order of nm in terms of the number average primary particle. It is possible to determine the diameter employing an Electrophoretic Light Scattering Spectrophotometer “ELS-800” (manufactured by Otsuka Electronics Co., Ltd.).

The structure employed such preferable toner as well as the production method of the same will now be described in detail.

<Toner>

It is preferable that a coalesced type toner is employed, which is prepared by salting out and fusing resinous particles comprising release agents and colorant particles.

As the reason for such toner, it is assumed that since it is possible to obtain toner having such particle size distribution, and the coalesced type toner particles each exhibits uniform surface properties, the effects of the present invention are exhibited without degrading transferability.

The “salting-out/fusion”, as described above, refers to simultaneous occurrence of salting-out (aggregation of particles) and fusion (disappearance of the boundary surface among particles) or an operation to render salting-out and fusion to occur simultaneously. In order to render salting-out and fusion to occur simultaneously, it is necessary to aggregate particles (resinous particles and colorant particles) at temperatures higher than or equal to the glass transition temperature (Tg) of resins constituting the resinous particles.

<Releasing Agent>

A releasing agent which constitutes the toner is not particularly limited.

It is desirable that the releasing agent comprised of a crystalline ester compound (hereinafter it is referred as “a specific ester compound”) shown by the following general formula (1).

General-formula (1): R1—(OCO—R2) n

(In the formula, R1 and R2, each represents hydrocarbon group having 1 to 40 carbon atoms and each may have the substituent, and n is the integer of 1-4.)

<Specific Ester Compound>

In the general formula (1) showing a specific ester compound, R1 and R2 each shows the hydrocarbon group which may have the substituent.

The number of carbon atoms of a hydrocarbon group R1 is 1-40, preferably 1-20, and still more preferably 2-5. The number of carbon atoms of a hydrocarbon group R2 is 1-40, preferably 16-30, and still more preferably 18-26.

In the formula n is an integer from 1 to 4, preferably from 2 to 4, and more preferably 3 or 4, and particularly 4.

The specific ester compound can be synthesized by a dehydration condensation reaction of an alcohol compound and a carbonic acid adequately.

Most preferable example of the ester compound is pentaerthritoltetrabehanate.

Representative examples are listed as compounds 1 to 26. 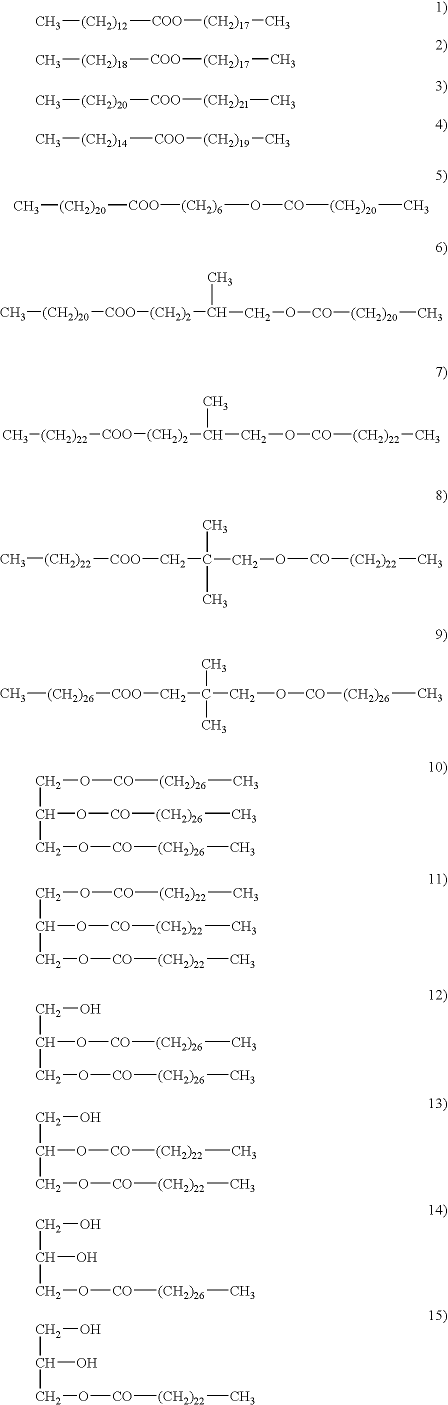
<The Content Rate of a Releasing Agent>

The content ratio of the releasing agent in the toner is commonly from 1 to 30 percent by weight, is preferably from 2 to 20 percent by weight, and is particularly preferably from 3 to 15 percent by weight.

<Resinous Particles Comprising a Releasing Agents>

The “resinous particles containing releasing agents”, may be obtained as latex particles by dissolving releasing agents in monomers to obtain binding resins, and then dispersing the resulting monomer solution into water based medium, and subsequently polymerizing the resulting dispersion.

The weight average particle diameter of said resinous particles is preferably 50 to 2,000 nm. Listed as polymerization method employed to obtain resinous particles, in which binding resins comprise releasing agents, may be granulation polymerization methods such as an emulsion polymerization method, a suspension polymerization method, a seed polymerization method, and the like.

The following method (hereinafter referred to as “mini-emulsion method”) may be cited as a preferable polymerization method to obtain resinous particles comprising releasing agents. A monomer solution, which is prepared by dissolving releasing agents in monomers, is dispersed into a water based medium prepared by dissolving surface active agents in water at a concentration of less than the critical micelle concentration so as to form oil droplets in water, while utilizing mechanical force. Subsequently, water-soluble polymerization initiators are added to the resulting dispersion and the resulting mixture undergoes radical polymerization. Further, instead of adding said water-soluble polymerization initiators, or along with said water-soluble polymerization initiators, oil-soluble polymerization initiators may be added to said monomer solution.

Herein, homogenizers which results in oil droplets in water dispersion, utilizing mechanical force, are not particularly limited, and may include “CLEARMIX” (produced by M Tech Co., Ltd.) provided with a high speed rotor, ultrasonic homogenizers, mechanical homogenizers, Manton-Gaulin homogenizers, pressure type homogenizers, and the like. Further, the diameter of dispersed particles is generally 10 to 1,000 nm, and is preferably 30 to 300 nm.

<Binding Resins>

Binding resins, which constitute the toner of the present invention, preferably comprise high molecular weight components having a peak, or a shoulder, in the region of 100,000 to 1,000,000, as well as low molecular weight components having a peak, or a shoulder, in the region of 1,000 to 20,000 in terms of the molecular weight distribution determined by GPC.

Herein, the method for measuring the molecular weight of resins, employing GPC, is as follows. Added to 1 ml of THF is a measured sample in an amount of 0.5 to 5.0 mg (specifically, 1 mg), and is sufficiently dissolved at room temperature while stirring employing a magnetic stirrer and the like. Subsequently, after filtering the resulting solution employing a membrane filter having a pore size of 0.45 to 0.50 μm, the filtrate is injected in a GPC.

Measurement conditions of GPC are described below.

A column is stabilized at 40° C., and THF is flowed at a rate of 1 ml per minute. Then measurement is carried out by injecting approximately 100 μl of said sample at a concentration of 1 mg/ml. It is preferable that commercially available polystyrene gel columns are combined and used. For example, it is possible to cite combinations of Shodex GPC KF-801, 802, 803, 804, 805, 806, and 807, produced by Showa Denko Co., combinations of TSKgel G1000H, G2000H, G3000H, G4000H, G5000H, G6000H, G7000H, TSK guard column, and the like produced by Toso co. Further, as a detector, a refractive index detector (IR detector) or a UV detector is preferably employed. When the molecular weight of samples is measured, the molecular weight distribution of said sample is calculated employing a calibration curve which is prepared employing monodispersed polystyrene as standard particles. Approximately ten polystyrenes samples are preferably employed for determining said calibration curve.

The composition materials of resinous particles and the preparation thereof will now be described.

[Monomer]

Of polymerizable monomers which are employed to prepare resinous particles, radical polymerizable monomers are essential components, and if desired, crosslinking agents may be employed. Further, at least one of said radical polymerizable monomers having an acidic group or radical polymerizable monomers having a basic group, described below, is preferably incorporated.

(1) Radical Polymerizable Monomers

Radical polymerizable monomers are not particularly limited.

It is possible to employ conventional radical polymerizable monomers known in the art. Further, they may be employed in combination of two or more types so as to satisfy desired properties. Specifically, employed may be aromatic vinyl monomers, acrylic acid ester based monomers, methacrylic acid ester based monomers, vinyl ester based monomers, vinyl ether based monomers, monoolefin based monomers, diolefin based monomers, halogenated olefin monomers, and the like. Listed as aromatic vinyl monomers, for example, are styrene based monomers and derivatives thereof such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrne, p-n-nonylstyrene, p-n-decylstyrene, p-n-dodecylstyrene, 2,4-dimethylstyrne, 3,4-dichlorostyrene, and the like.

Listed as acrylic acid ester bases monomers and methacrylic acid ester monomers are methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl.beta.-hydroxyacrylate, propyl .gamma.-aminoacrylate, stearyl methacrylate, dimethyl aminoethyl methacrylate, diethyl aminoethyl methacrylate, and the like.

Listed as vinyl ester based monomers are vinyl acetate, vinyl propionate, vinyl benzoate, and the like. Listed as vinyl ether based monomers are vinyl methyl ether, vinyl ethyl ether, vinyl isobutyl ether, vinyl phenyl ether, and the like.

Listed as monoolefin based monomers are ethylene, propylene, isobutylene, 1-butene, 1-pentene, 4-methyl-1-pentene, and the like.

Listed as diolefin based monomers are butadiene, isoprene, chloroprene, and the like.

Listed as halogenated olefin based monomers are vinyl chloride, vinylidene chloride, vinyl bromide, and the like.

(2) Cross Linking Agent:

In order to improve the desired properties of toner, added as crosslinking agents may be radical polymerizable crosslinking agents. Listed as radical polymerizable agents are those having at least two unsaturated bonds such as divinylbenzene, divinylnaphthalene, divinyl ether, diethylene glycol methacrylate, ethylene glycol dimethacrylate, polyethylene glycol dimethacrylate, phthalic acid diallyl, and the like.

(3) Radical Polymerizable Monomers Having an Acidic Group or a Basic Group

Employed as radical polymerizable monomers having an acidic group or a basic group may, for example, be monomers having a carboxyl group, monomers having a sulfonic acid group, and amine based compounds such as primary, secondary, and tertiary amines, quaternary ammonium salts, and the like.

Listed as radical polymerizable monomers having an acidic group are acrylic acid, methacrylic acid, fumaric acid, maleic acid, itaconic acid, cinnamic acid, monobutyl maleate, monooctyl maleate and the like as monomers having a carboxyl group.

Listed as monomers having sulfonic acid are styrenesulfonic acid, allylsulfosuccinic acid, octyl allylsulfosuccinate, and the like.

These may be in the form of salts of alkali metals such as sodium or potassium, or salts of alkali earth metals such as calcium and the like.

Listed as radical polymerizable monomers having a basic group are amine based compounds which include dimethyl aminoethyl acrylate, dimethyl aminoethyl methacrylate, diethyl aminoethyl acrylate, diethyl aminoethyl methacrylate, and quaternary ammonium salts of said four compounds;
3-dimethylaminophenyl acrylate, 2-hydroxy-3-methacryloxypropyl-trimethylammonium salt;
acrylamide, N-butylacrylamide, N,N-dibutylacrylamide, piperidylacrylamide, methacrylamide, N-butylmethacrylamide, N-octadecylacrylamide; vinylpyridine; vinylpyrrolidone;
vinyl N-methylpyridinium chloride, vinyl N-ethylpyridinium chloride, N,N-diallylmethylammonium chloride, N,N-diallylethylammonium chloride; and the like.

The content ratio of radical polymerizable monomers having an acidic group or a basic group is preferably 0.1 to 15 percent by weight with respect to the total monomers.

The content ratio of radical polymerizable crosslinking agents is preferably 0.1 to 10 percent by weight with respect to the total radical polymerizable monomers, depending on the nature of crosslinking agent.

[Chain Transfer Agent]

For the purpose of regulating the molecular weight of resinous particles, it is possible to employ commonly used chain transfer agents.

Said chain transfer agents are not particularly limited, and for example, employed are mercaptans such as octylmercaptan, dodecylmercaptan, tert-dodecylmercaptan, and the like, mercaptopropionic acid ester, such as n-octyl-3-mercaptopropionic acid ester and the like, and carbon tetrabromide, styrene dimer, and the like.

[Polymerization Initiators]

Radical polymerization initiators may be suitably employed in the present invention, as long as they are water-soluble. For example, listed are persulfate salts (potassium persulfate, ammonium persulfate, and the like), azo based compounds (4,4′-azobis-4-cyanovaleric acid and salts thereof, 2,2′-azobis(2-amidinopropane) salts, and the like), peroxides, and the like.

Further, if desired, it is possible to employ said radical polymerization initiators as redox based initiators by combining them with reducing agents. By employing said redox based initiators, it is possible to increase polymerization activity and decrease polymerization temperature so that a decrease in polymerization time is expected.

It is possible to select any polymerization temperature, as long as it is not lower than the lowest radical formation temperature of said polymerization initiator.

For example, the temperature range of 50 to 90° C. is employed. However, by employing a combination of polymerization initiators such as hydrogen peroxide-reducing agent (ascorbic acid and the like), which is capable of initiating the polymerization at room temperature, it is possible to carry out polymerization at least room temperature.

[Surface Active Agent]

In order to perform polymerization employing the aforementioned radical polymerizable monomers, it is required to conduct oil droplet dispersion in a water based medium employing surface active agents. Surface active agents, which are employed for said dispersion, are not particularly limited, and it is possible to cite ionic surface active agents described below as suitable ones.

Listed as ionic surface active agents are sulfonic acid salts (sodium dodecylbenzenesulfonate, sodium aryl alkyl polyethersulfonate, sodium 3,3-disulfondiphenylurea-4,4-diazo-bis-amino-8-naphthol-6-sulfonate, sodium ortho-caroxybenzene-azo-dimethylaniline-2,2,5,5-tetramethyl-triphenylmethane-4,4-diazo-bis-.beta.-naphthol-6-sulfonate, and the like), sulfuric acid ester salts (sodium dodecylsulfonate, sodium tetradecylsulfonate, sodium pentadecylsulfonate, sodium octylsulfonate, and the like), fatty acid salts (sodium oleate, sodium laureate, sodium caprate, sodium caprylate, sodium caproate, potassium stearate, calcium oleate, and the like).

Further, nonionic surface active agents may be employed. Specifically, it is possible to cite polyethylene oxide, polypropylene oxide, a combination of polypropylene oxide and polyethylene oxide, alkylphenol polyethylene oxide, esters of polyethylene glycol with higher fatty acids, esters of polypropylene oxide with higher fatty acids, sorbitan esters, and the like.

<Coloring Agent>

Listed as colorants which constitute the toner of the present invention may be inorganic pigments, organic pigments, and dyes.

Employed as said inorganic pigments may be those conventionally known in the art. Specific inorganic pigments are listed below.

Employed as black pigments are, for example, carbon black such as furnace black, channel black, acetylene black, thermal black, lamp black, and the like, and in addition, magnetic powders such as magnetite, ferrite, and the like.

If desired, these inorganic pigments may be employed individually or in combination of a plurality of these.

Further, the added amount of said pigments is commonly between 2 and 20 percent by weight with respect to the polymer, and is preferably between 3 and 15 percent by weight.

When employed as a magnetic toner, it is possible to add said magnetite. In that case, from the viewpoint of providing specified magnetic properties, said magnetite is incorporated into said toner preferably in an amount of 20 to 60 percent by weight.

The organic pigments and dyes may be employed. Specific organic pigments as well as dyes are exemplified below.

Listed as pigments for magenta or red are C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and the like.

Listed as pigments for orange or yellow are C.I. Pigment orange 31, C.I. Pigment Orange 43, C.I. Pigment Yellow 12, C.I. Pigment Yellow 13, C.I. Pigment Yellow 14, C.I. Pigment yellow 15, C.I. Pigment Yellow 17, C.I. Pigment Yellow 93, C.I. Pigment Yellow 94, C.I. Pigment Yellow 138, C.I. Pigment Yellow 155, C.I. Pigment Yellow 156, C.I. Pigment yellow 180, C.I. Pigment Yellow 185, and the like.

Listed as pigments for green or cyan are C.I. Pigment Blue 15, C.I. Pigment Blue 15:2, C.I. Pigment Blue 15:3, C.I. Pigment Blue 16, C.I. Pigment Blue 60, C.I. Pigment Green 7, and the like.

Employed as dyes may be C.I. Solvent Red 1, 49, 52, 58, 63, 111, 122; C.I. Solvent Yellow 19, 44, 77, 79, 81, 82, 93, 98, 103, 104, 112, 162; C.I. Solvent Blue 25, 36, 60, 70, 93, and 95; and the like. Further these may be employed in combination.

These organic pigments, as well as dyes, may be employed individually or in combination of selected ones, if desired. Further, the added amount of pigments is commonly between 2 and 20 percent by weight, and is preferably between 3 and 15 percent by weight.

The colorants may also be employed while subjected to surface modification. As the surface modifying agents may be those conventionally known in the art, and specifically, preferably employed may be silane coupling agents, titanium coupling agents, aluminum coupling agents, and the like.

<External Additives>

For the purpose of improving fluidity as well as chargeability, and of enhancing cleaning properties, the toner of the present invention may be employed into which so-called external additives are incorporated. Said external additives are not particularly limited, and various types of fine inorganic particles, fine organic particles, and lubricants may be employed.

Employed as fine inorganic particles may be those conventionally known in the art. Specifically, it is possible to preferably employ fine silica, titanium, and alumina particles and the like. These fine inorganic particles are preferably hydrophobic. pecifically listed as fine silica particles, for example, are commercially available R-805, R-976, R-974, R-972, R-812, and R-809, produced by Nippon Aerosil Co.; HVK-2150 and H-200, produced by Hoechst Co.; commercially available TS-720, TS-530, TS-610, H5, and MS5, produced by Cabot Corp; and the like.

Listed as fine titanium particles, for example, are commercially available T-805 and T-604, produced by Nippon Aerosil Co.; commercially available MT-100S, MT-100B, MT-500BS, MT-600, MT-600SS, and JA-1, produced by Teika Co.; commercially available TA-300SI, TA-500, TAF-130, TAF-510, and TAF-510T, produced by Fuji Titan Co.; commercially available IT-S, IT-OA, IT-OB, and IT-OC, produced by Idemitsu Kosan Co.; and the like.

Listed as fine alumina particles, for example, are commercially available RFY-C and C-604, produced by Nippon Aerosil Co., commercially available TTO-55, produced by Ishihara Sangyo Co., and the like. Further, employed as fine organic particles are fine spherical organic particles having a number average primary particle diameter of 10 to 2,000 nm.

Employed as such particles may be homopolymers or copolymers of styrene or methyl methacrylate.

Listed as lubricants, for example, are metal salts of higher fatty acids, such as salts of stearic acid with zinc, aluminum, copper, magnesium, calcium, and the like; salts of oleic acid with zinc, manganese, iron, copper, magnesium, and the like; salts of palmitic acid with zinc, copper, magnesium, calcium, and the like; salts of linoleic acid with zinc, calcium, and the like; and salts of ricinolic acid with zinc, calcium, and the like.

The added amount of these external agents is preferably 0.1 to 5 percent by weight with respect to the toner.

The toner of the present invention is preferably a coalesced type toner obtained by salting out/fusing resinous particles comprising releasing agents and colorant particles in a water based medium. By salting out/fusing said resinous particles comprising releasing agents, as described above, a toner is obtained in which said releasing agents are finely dispersed.

In addition it is possible to perform the effects of stability of charging property and the like as well as the effects of distribution of the particles.

In addition, the toner of the present invention possesses an uneven surface from the production stage, and a coalesced type toner is obtained by fusing resinous particles and colorant particles. Therefore, differences in the shape as well as surface properties among toner particles are minimal. As a result, the surface properties tend to be uniform. Thus difference in fixability among toner particles tends to be minimized so that it is possible to maintain excellent fixability.

<Production Process of a Toner>

One example of the method for producing the toner is as follows:
(1) a dissolution process in which releasing agents are dissolved in monomers and a monomer solution is prepared
(2) a dispersion process in which the resulting monomer solution is dispersed into a water based medium
(3) a polymerization process in which the resulting water based dispersion of said monomer solution undergoes polymerization so that dispersion (latex) of resinous particles comprising said releasing agents is prepared
(4) a salting-out/fusion process in which the resulting resinous particles and said colorant particles are subjected to salting-out/fusion in a water based medium so as to obtain coalesced particles (toner particles)
(5) a filtration and washing process in which the resulting coalesced particles are collected from the water based medium employing filtration, and surface active agents and the like are removed from said coalesced particles.
(6) a drying process in which washed coalesced particles are dried, and
(7) an external addition process may be included in which external agents are added to the dried coalesced particles.
   [Dissolution Process]

Methods for dissolving releasing agents in monomers are not particularly limited. The dissolved amount of said releasing agents in said monomers is determined as follows: the content ratio of releasing agents is generally 1 to 30 percent by weight with respect of the finished toner, is preferably 2 to 20 percent by weight, and is more preferably 3 to 15 percent by weight.

Further, oil-soluble polymerization initiators as well as other oil-soluble components may be incorporated into said monomer solution.

[Dispersion Process]

Methods for dispersing said monomer solution into a water based medium are not particularly limited. However, methods are preferred in which dispersion is carried out employing mechanical force. Said monomer solution is preferably subjected to oil droplet dispersion (essentially an embodiment in a mini-emulsion method), employing mechanical force, especially into a water based medium prepared by dissolving a surface active agent at a concentration of lower than its critical micelle concentration.

Herein, homogenizers to conduct oil droplet dispersion, employing mechanical forces, are not particularly limited, and include, for example, “CLEARMIX”, ultrasonic homogenizers, mechanical homogenizers, and Manton-Gaulin homogenizers and pressure type homogenizers. Further, the diameter of dispersed particles is 10 to 1,000 nm, and is preferably 30 to 300 nm.

[Polymerization Process]

In the polymerization process, polymerization methods (granulation polymerization methods such as an emulsion polymerization method, a suspension polymerization method, and a seed polymerization method) may be employed.

Listed as one example of the preferred polymerization method may be a mini-emulsion method, namely in which radical polymerization is carried out by adding water-soluble polymerization initiators to a dispersion obtained by oil droplet dispersing a monomer solution, employing mechanical force, into a water based medium prepared by dissolving a surface active agent at a concentration lower than its critical micelle concentration.

[Salting-Out/Fusing Process]

In the salting-out/fusion process, a colorant particle dispersion is added to a dispersion containing resinous particles obtained by said polymerization process so that said resinous particles and said colorant particles are subjected to salting-out/fusion in a water based medium.

Further, in said salting-out/fusion process, resinous particles as well as colorant particles may be fused with internal additive agent particles such as a charge control agents and the like.

“Water based medium”, as described in said salting-out/fusion process, refers to one in which water is a main component (at least 50 percent by weight). Herein, components other than water may include water-soluble organic solvents.

Listed as examples are methanol, ethanol, isopropanol, butanol, acetone, methyl ethyl ketone, tetrahydrofuran, and the like. Of these, preferred are alcohol based organic solvents such as methanol, ethanol, isopropanol, butanol, and the like which do not dissolve resins.

It is possible to prepare colorant particles employed in said salting-out/fusion process by dispersing colorants into a water based medium. Dispersion of colorants is carried out in such a state that the concentration of surface active agents in water is adjusted to at least critical micelle concentration.

Homogenizers to disperse colorants are not particularly limited, and preferably listed are “Clearmix”, ultrasonic homogenizers, mechanical homogenizers, Manton-Gaulin and pressure type homogenizers, and medium type homogenizers such as sand grinders, Getman mill, diamond fine mills and the like. Further, listed as surface active agents may be the same as those previously described.

Further, colorants (particles) may be subjected to surface modification. The surface modification method is as follows.

Colorants are dispersed into a solvent, and surface modifiers are added to the resulting dispersion. Subsequently the resulting mixture is heated so as to undergo reaction. After completing said reaction, colorants are collected by filtration and repeatedly washed with the same solvent.

Subsequently, the washed colorants are dried to obtain the colorants (pigments) which are treated with said surface modifiers.

The salting-out/fusion process is accomplished as follows. Salting-out agents, containing alkaline metal salts and/or alkaline earth metal salts and the like, are added to water comprising resinous particles as well as colorant particles as the coagulant at a concentration of higher than critical aggregation concentration. Subsequently, the resulting aggregation is heated above the glass transition point of said resinous particles so that fusion is carried out while simultaneously conducting salting-out.

During this process, organic solvents, which are infinitely soluble in water, may be added.

Herein, listed as alkali metals and alkali earth metals, employed as salting-out agents, are, as alkali metals, lithium, potassium, sodium, and the like, and as alkali earth metals, magnesium, calcium, strontium, barium, and the like. Preferably, listed as potassium, sodium, magnesium, calcium, barium, are employed.

Further, listed as those forming salts are chlorides, bromides, iodides, carbonates, sulfates, and the like.

Further, listed as said organic solvents, which are infinitely soluble in water, are alcohols such as methanol, ethanol, 1-propanol, 2-propanol, ethylene glycol, glycerin, acetone, and the like. Of these, preferred are methanol, ethanol, 1-propanol, and 2-propanol which are alcohols having not more than 3 carbon atoms. In the salting-out/fusion process, it is preferable that hold-over time after the addition of salting-out agents is as short as possible.

Namely it is preferable that after the addition of salting-out agents, dispersion containing resinous particles and colorant particles is heated as soon as possible and heated to a temperature higher than the glass transition point of said resinous particles.

The reason for this is not well understood.

However, problems occur in which the aggregation state of particles varies depending on the hold-over time after salting out so that the particle diameter distribution becomes unstable and surface properties of fused toner particles fluctuate. Time before initiating heating (hold-over time) is commonly not more than 30 minutes, and is preferably not more than 10 minutes. Temperatures, at which salting-out agents are added, are not particularly limited, and are preferably no higher than the glass transition temperature of resinous particles.

Further, it is required that in the salting-out/fusion process, the temperature is quickly increased by heating.

The rate of temperature increase is preferably no less than 1° C./minute. The maximum rate of temperature increase is not particularly limited. However, from the viewpoint of minimizing the formation of coarse grains due to rapid salting-out/fusion, said rate is preferably not more than 15° C./minute.

Further, after the dispersion containing resinous particles and colorant particles is heated to a same or higher temperature than said glass transition point, it is important to continue the salting-out/fusion by maintaining the temperature of said dispersion for a specified period of time. By so doing, it is possible to effectively proceed with the growth of toner particles (aggregation of resinous particles as well as colorant particles) and fusion (disappearance of the interface between particles. As a result, it is possible to enhance the durability of the finally obtained toner.

Further, after terminating the growth of coalesced particles, fusion by heating may be continued.

[Filtration/Washing Process]

In said filtration and washing process, carried out is filtration in which toner particles are collected from the toner particle dispersion obtained by the process previously described, and adhered materials such as surface active agents, salting-out agents, and the like, are removed from the collected toner particles (a caked aggregation).

Herein, the filtration methods are not particularly limited, and include a centrifugal separation method, a vacuum filtration method which employes is a nutsche etc., a filtration method which is carried out employing a filter press, and the like.

[Drying Process]

This process is the process to dry washed toner particles. Listed as dryers employed in this process may be spray dryers, vacuum freeze dryers, vacuum dryers, and the like. Further, standing tray dryers, movable tray dryers, fluidized-bed layer dryers, rotary dryers, stirring dryers, and the like are preferably employed.

It is proposed that the moisture content of dried toners is preferably not more than 5 percent by weight, and is more preferably not more than 2 percent by weight.

Further, when dried toner particles are aggregated due to weak attractive forces among particles, aggregates may be subjected to pulverization treatment. Herein, employed as pulverization devices may be mechanical pulverization devices such as a jet mill, a Henschel mixer, a coffee mill, a food processor, and the like.

[Addition Process of External Additives]

This process is one in which external additives are added to dried toner particles.

Listed as devices which are employed for the addition of external additives, may be various types of mixing devices known in the art, such as tubular mixers, Henschel mixers, Nauter mixers, V-type mixers, and the like.

The proportion of number of toner particles having a diameter of at most 0.7× (Dp50) can be 10 percent or less.

It is preferable to control the temperature during the salting-out/fusion narrow for obtaining toner particles satisfying such condition.

More in concrete temperature is elevated as fast as possible. The time for elevation is preferably less than 30 minutes, more preferably less than 10 minutes, and the elevation rate is preferably 1 to 15° C./minutes.

Besides colorants and releasing agents, materials, which provide various functions as toner materials may be incorporated into the toner of the present invention.

Specifically, charge control agents are cited.

Said agents may be added employing various methods such as one in which during the salting-out/fusion stage, said charge control agents are simultaneously added to resinous particles as well as colorant particles so as to be incorporated into the toner, another is one in which said charge control agents are added to resinous particles, and the like. In the same manner, it is possible to employ various charge control agents, which can be dispersed in water. Specifically listed are nigrosine based dyes, metal salts of naphthenic acid or higher fatty acids, alkoxyamines, quaternary ammonium salts, azo based metal complexes, salicylic acid metal salts or metal complexes thereof.

<Developers>

The toner of the present invention may be employed in either a single-component developer or a two-component developer.

Listed as single-component developers are a non-magnetic single-component developer, and a magnetic single-component developer in which magnetic particles having a diameter of 0.1 to 0.5 μm are incorporated into a toner. Said toner may be employed in both developers.

Further, said toner is blended with a carrier and employed as a two-component developer.

In this case, employed as magnetic particles of the carrier may be conventional materials known in the art, such as metals such as iron, ferrite, magnetite, and the like, alloys of said metals with aluminum, lead and the like.

Specifically, ferrite particles are preferred.

The volume average particle diameter of said magnetic particles is preferably 15 to 100 μm, and is more preferably 25 to 80 μm.

The volume average particle diameter of said carrier can be generally determined employing a laser diffraction type particle size distribution measurement apparatus “HELOS”, produced by Sympatec Co., which is provided with a wet type homogenizer.

The preferred carrier is one in which magnetic particles are further coated with resins, or a so-called resin dispersion type carrier in which magnetic particles are dispersed into resins. Resin compositions for coating are not particularly limited. For example, employed are olefin based resins, styrene based resins, styrene-acryl based resins, silicone based resins, ester based resins, or fluorine containing polymer based resins.

Further, resins, which constitute said resin dispersion type carrier, are not particularly limited, and resins known in the art may be employed. For example, listed may be styrene-acryl based resins polyester resins, fluorine based resins, phenol resins, and the like.

### EXAMPLE

Hereinafter, one example of the embodiment is explained by showing examples, but aspects of the invention are not limited to these examples.

Incidentally, “part” in the following sentences represents “parts by weight”.

### Example A

Manufacture of Photoreceptor

Manufacture of Photoreceptor 1

The following dispersions were prepared and coated on a cylindrical aluminum base substance obtained by a drawing process, thereby an electrically conductive layer having a dry film thickness of 15 μm was formed.

<Electrically Conductive Layer (PCL) Composition Liquid>

| | |
|---|---|
| Phenol resin | 160 parts |
| conductive titania pigment | 200 parts |
| Methyl cellosolve | 100 parts |

The following intermediate layer composition liquid was prepared. This composition liquid was coated by a dip coating method (immersion coating method) on the conductive layer, thereby an intermediate layer having a film thickness of 1.0 μm was formed.

<Intermediate Layer (UCL) Composition Liquid>

| | |
|---|---|
| Polyamide resin (Amilan CM-8000: | 60 parts |
| product made in Toray company) | |
| Methanol | 1600 parts |
| 1-butanol | 400 parts |

The following coating composition liquids were mixed and dispersed by means of sand mill for ten hours, thereby electric charge generating layer coating liquid was prepared.

This coating liquid was coated by a dip coating method on the intermediate layer, thereby an electric charge generating layer of dry film thickness 0.2 μm was formed.

<Electric Charge Generating layer (CGL) Composition Liquid>

| | |
|---|---|
| Oxytitanylphthalocyanine pigment (having the maximum | 60 parts |
| peak angle of X-ray diffraction by Cu-Kα characteristic X- | |
| ray at an angle 2θ of 27.3°) | |
| Silicone resin solution (KR5240, 15% xylene-butanol | 700 parts |
| solution: product made by Shinetsu chemistry company) | |
| 2-butanone | 2000 parts |

The following coating composition liquids were mixed and dissolved, thereby an electric charge transporting layer coating liquid was prepared. This coating liquid was coated by a dip coating method on the electric charge generating layer, thereby a charge transporting layer having a dry film thickness of 20 μm was formed and a photoreceptor 1 was produced. Rz of the photo conductor was 0.07 μm.

<Charge Transporting Layer (CTL) Composition Liquid>

| | |
|---|---|
| Charge transport material (N-(4-methylphenyl)-N-{4- | 200 parts |
| (β-phenyl styryl) phenyl}-p-toluidine) | |
| Bisphenol Z type polycarbonate (Eupilon Z300: products | 300 parts |
| refined once with methanol and produced by Mitsubishi Gas | |
| Chemical company) | |
| 1,2-dichloroethane | 2000 parts |

Manufacture of Photoreceptor 2

The following intermediate layer composition liquid was coated by a dip coating method on a cylindrical aluminum base substance which was machined by a cutting process with a cutting tool so as to have a ten point surface roughness Rz of 0.1 μm, and dried for 30 minutes under a temperature of 150° C., thereby an intermediate layer having a thickness of 1.0 μm was formed.

<Intermediate Layer (UCL) Composition Liquid>

| | |
|---|---|
| zirconium chelate compound ZC-540 (Matsumoto | 200 parts |
| pharmaceutical Co., Ltd.) | |
| Silane coupling agent KBM-903 (Shinetsu chemistry Co., | 100 parts |
| Ltd.) | |
| Methanol | 700 parts |
| Ethanol | 300 parts |

The following coating composition liquids were mixed and dispersed by means of sand mill for ten hours, thereby electric charge generating layer coating liquid was prepared.

This coating liquid was coated by a dip coating method on the intermediate layer, thereby an electric charge generating layer of dry film thickness 0.2 μm was formed.

<Electric Charge Generating Layer (CGL) Composition Liquid>

| | |
|---|---|
| Oxytitanylphthalocyanine pigment (having the maximum | 60 parts |
| peak angle of X-ray diffraction by Cu-Kα characteristic X- | |
| ray at an angle 2θ of 27.3°) | |
| Silicone resin solution (KR5240, 15% xylene-butanol | 700 parts |
| solution: product made by Shinetsu chemistry company) | |
| 2-butanone | 2000 parts |

The following coating composition liquids were mixed and dissolved, thereby an electric charge transporting layer coating liquid was prepared. This coating liquid was coated by a dip coating method on the electric charge generating layer, thereby the charge transporting layer having a film thickness of 20 μm was formed and photoreceptor 2 was produced. Rz of the photo conductor was 3.0 μm.

<Charge Transporting Layer (CTL) Composition Liquid>

| | |
|---|---|
| Charge transport material (N-(4-methylphenyl)-N-{4- | 200 parts |
| (β-phenyl styryl) phenyl}-p-toluidine) | |
| Bisphenol Z type polycarbonate (Eupilon Z300: products | 300 parts |
| produced by Mitsubishi Gas Chemical company) | |
| 1,2-dichloroethane | 2000 parts |
| Teflon (R) fine particles (heat treatment product of | 100 parts |
| five mean particle size μm) | |

Manufacture of Photoreceptor 3

The following application composition liquids were mixed, dissolved, thereby preparing a protective layer application composition which was coated on CTL of photo conductor 2.

<Potective Layer (OCL) Composition Liquid>

Molecular sieve 4A were added in 10 weight parts of poly siloxane resin comprising 80 mol % of methylsiloxane unit and 20 mol % of methyl-phenyl siloxane unit, still standing was done for them for 24 hours, and then dehydration process was conducted for them. This resin is dissolved in 10 weight parts of toluene, and 5 weight parts of methyl trimethoxysilane, 0.2 weight parts of dibutyl tin acetate were added so as to make it uniform solution. Six weight parts of dihydroxymethyl triphenyl amine (the following compound) were added into this solution and it was mixed. This solution was coated as a protective layer of 2 μm mdry film thickness, and heating hardening processs was conducted for it under 130 degrees Celsius for 1 hour stiffen so as to produce a photo conductor 3. Rz of the photo conductor was 1.3 μm. 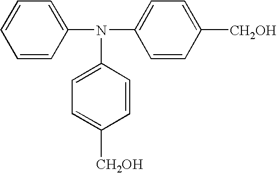
Manufacture of Photoreceptor 4

The following intermediate layer composition liquid was coated by a dip coating method on a cylindrical aluminum base substance which was machined by a cutting process with a cutting tool so as to have a ten point surface roughness Rz of 0.5 μm, and thereby an intermediate layer having a dry thickness of 2.0 μm was formed.

<Intermediate Layer (UCL) Composition Liquid>

The following interlayer dispersion liquid was diluted in a double in the same solvent mixture, filtration (filter; re-dimesh filter producded by Japan pole company, nominal rating filtration accuracy: 5 micron, pressure; 0.05 MPa) was done after settling for single night so that interlayer composition liquid was made.

(Manufacture of Interlayer Dispersion Liquid)

| | | |
|---|---|---|
| Polyamide resin CM 8000 (a product made in Toray | 1 | part |
| company) | | |
| Titanium oxide STM 500 SAS (a product made in Tayca | 3.0 | parts |
| company; surface treatment processes by silica treatment, | | |
| alumina treatment and methylhydrozinpolysiloxane treatment) | | |
| Methanol | 10 | parts |

Interlayer dispersion liquid was made by dispersion by batch process with sand mill as a disperser for 10 hours dispersion time.

The following coating composition liquids were mixed and dispersed by means of sand mill, thereby an electric charge generating layer composition liquid was prepared. This composition liquid was coated in dipping coating method, a charge generation layer of 0.3 μm drying film thickness was formed on the interlayer.

<Electric Charge Generating Layer (CGL) Composition Liquid>

| | | |
|---|---|---|
| Oxytitanylphthalocyanine pigment (having the maximum | 20 | parts |
| peak angle of X-ray diffraction by Cu-Kα characteristic X- | | |
| ray at an angle 2θ of 27.3°) | | |
| Polyvinylbutyral (# 6000-C, product made by Denki | 10 | part |
| Kagaku Kogyo company) | | |
| Acetic acid t-butyl | 700 | parts |
| 4-methoxy-4-methyl-2-pentanone | 300 | parts |

The following composition liquids were mixed and dissolved, thereby an electric charge transporting layer composition liquid was prepared. This composition liquid was coated by a dip coating method on the electric charge generating layer, thereby the charge transporting layer having a film thickness of 24 μm was formed and photoreceptor 4 was produced. Rz of the photo conductor was 0.2 μm.

<Charge Transporting Layer (CTL) Composition Liquid>

| | |
|---|---|
| Charge transport material (N-(4-methylphenyl)-N-{4- | 75 parts |
| (β-phenyl styryl) phenyl}-p-toluidine) | |
| Polycarbonate resin (you pyron Z300, a product made in | 100 parts |
| Mitsubishi Gas Chemical company) | |
| Dichloromethane | 750 parts |
| Silica (average particle diameter 0.5 μm, silicone oil | 20 parts |
| treatment) | |

Manufacture of Photoreceptor 5

Instead of silica microparticle of the charge transport layer of photo conductor 4, except the use of 5 μm mean particle size, photo conductor 5 was produced with the procedure as same as photo conductor 4. Rz was 4.3 μm.

Manufacture of Photoreceptor 6

Mirror surface-processed product of Rz 0.001 μm was used in substrate of photo conductor 4, except that silica microparticle was not used for CTL, photo conductor 6 was made as same as as photo conductor 4. Rz was 0.03 μm.

Manufacture of Surface Energy Lowering Agent A-F

A sodium stearate was dissolved in water, thereby 15 wt % liquid was produced. Further, zinc sulfate was dissolved in water, thereby 25 wt % liquid was produced.

A receiving container having a volume of 2 liters with a stirring apparatus including a turbine blade having a diameter of 6 cm was prepared, and turbine blade was rotated in 350 rpm. A sodium stearate liquid is put into this receiving container, and the solution temperature was adjusted to 80° C. Next, zinc sulfate liquid which was heated to 80° C. was dropped into this receiving container over 30 minutes. An equivalence ratio of sodium stearate to zinc sulfate was made 0.98, the sodium stearate and the zinc sulfate were mixed such that the quantity of metallic soap slurry became 500 g. After the preparation for the total amount was completed, it was matured for 10 minutes under a temperature condition at the time of reaction, and then the reaction was completed. Next, the metallic soap slurry obtained in this way was twice washed with water, successively, it was washed by means of water. The thus obtained metallic soap cake was dried under a drying temperature of 110° C. A pressing process with a pressure of 150 kg/cm² was conducted, thereby making it solid.

Thereafter, It was left under an environmental condition of a temperature of 30° C. and a humidity of 80% RH for 24 hours. A solid material (surface energy lowering agents A-F) of zinc stearate whose water content was changed as shown in table 1, were obtained. The water contents of A-F were adjusted by changing a drying time under a temperature of 110° C.

Manufacture of Surface Energy Lowering Agent G

A heating and pressing process with a temperature of 80° C. and a pressure of 200 kg/cm² were conducted for fine grains of commercial Teflon (R), thereby a solid material was obtained. The solid material was left under an environmental condition of a temperature of 30° C. and a humidity of 80% RH for 24 hours, thereby Teflon (R) solid material (surface energy lowering agent G) having the water content of 0.8 wt % was obtained.

TABLE 1

| Kind of surface energy | Material |
|---|---|
| lowering agent | (water content: weight %) |
| A | Zinc stearate (0.05) |
| B | Zinc stearate (0.1) |
| C | Zinc stearate (1.0) |
| D | Zinc stearate (2.5) |
| E | Zinc stearate (4.5) |
| F | Zinc stearate (5.5) |
| G | Teflon (0.8) |

<Evaluation>

A cleaning means shown in FIG. 5 was mounted as a cleaning means for a photoreceptor of a digital color printer having an intermediate transfer member of FIG. 1, a kind of a photoreceptor, a kind of surface energy lowering agent, and a kind of an intermediate transfer member was combined in the digital color printer as shown in combinations in table 2. An image of pixel rate 8% was printed on 100000 sheets of A4 size paper continuously under a high-temperature of 30° C. and a high humidity of 80% RH by the printer, and the printed sheets were evaluated. Evaluation items are evaluations for the lacking of partial toner image and the scattering of character image, a cleaning-ability evaluation, and an image quality evaluation. Evaluation items and criterion for evaluation are shown below.

Further, evaluation results are shown in table 2. Evaluation item and criterion for evaluation

Measurement of Contact Angle of a Photoreceptor

After 100000 sheets of print were evaluated, the contact angle of a photoreceptor surface for a pure water was measured with a contact angle measuring instrument (CA-DT•A type: product made by Kyowa surface science company) under an environment of a temperature of 30° C. and a humidity of 80% RH.

“Occurrence of the Lacking of Partial Toner Image”

A character image was magnified and observed, and presence or absence of occurrence of the lacking of partial toner image was observed by visual observation.

Criterion for evaluation was as follows:

A: Until 100000 sheets of prints were completed, occurrence of remarkable lacking of partial toner image was not observed.

B: Until 50000 sheets of prints were completed, occurrence of remarkable lacking of partial toner image was not observed.

C: On a print of less than 50000 sheets, occurrence of remarkable lacking of partial toner image was observed.

“Evaluation of the Scattering of Character Image”

Instead of dot images constructing a character, a 10% halftone image was formed on the entire image surface, and the scattering of toner image around the dot was observed with a magnifying lens.

Rank A: Until 100000 sheets of print were completed, there was a little scattering of toner image.

Rank B: Until 50000 sheets of print were completed, there was a little scattering of toner image.

Rank C: On a print of less than 50000 sheets, scattering of toner image increased

Cleaning Ability Evaluation

Presence or absence of the occurrence of passing-through of a toner due to abrasion between a photoreceptor and a cleaning blade, and presence or absence of a rolled-up of blade (the phenomenon that a blade turns over or rolls up) were evaluated.

A: There was no occurrence of passing-through of a toner and rolled up of a blade, until 100000 sheets of print were completed.

B: Until 50000 sheets of print were completed, there was no occurrence of passing-through of a toner and rolled up of a blade,

C: On a print of less than 50000 sheets, there was an occurrence of passing-through of a toner or an occurrence of turned up of a blade.

Image Quality Evaluation

Image quality was evaluated whether or not the sufficient image density was obtained for each color, or was evaluated mainly on the sharpness of an image (whether an image is clear or blur).

Image density (it was measured using RD-918 made by Macbeth company with a relative reflection density in which a reflection density on a paper is made 0)

A: All of Y, M, C, and K (black) were more than 1.2

B: All of Y, M, C, and K were more than 0.8

C: At least one of Y, M, C, and K was less than 0.8

Sharpness of Image

Under an environment of a high-temperature and an a normal humidity (a temperature of 33° C., a relative humidity of 50%), an image of a thin line was printed, reproducibility and sharpness of the thin line image were evaluated based on character collapse of the thin line image. Character images of 3 points and 5 points were formed, the character images were evaluated with the following judgment criteria.

A: Both of the 3 point and 5 point character images were clear, and readable easily.

B: The 3 point character image was partially not readable, and the 5 point character image was clear and readable easily.

C: The 3 point character image was almost not readable, and the 5 point character image was partially not readable or almost not readable.

Other Conditions for Evaluation

Line speed L/S of image formation: 180 mm/s

An electrostatic charge condition of photoreceptor (60 mm diameter): electro potential of non-image section was detected with a potential sensor, and a feed back control was conducted in such a manner that a control range was −500V to −900V and the surface potential of the photoreceptor was controlled within a range of −50 to 0 V when an entire exposure was conducted.

Imagewise exposure light: semiconductor laser (wavelength: 780 nm)

Development condition: A developer of each of Y, M, C, K, is a two component developer composed of a toner having a number average particle diameter of 7.5 μm and carrier, and a development apparatus is a type corresponding to the two component developer.

Intermediate transfer member: A seamless endless belt-shaped intermediate transfer member 70 was used, and the belt was made of a semi conductive resin having a volume resistance ratio of 1×10⁸ Ωcm.

Two kinds having Rz of 0.9 μm and 1.5 μm in were used.

Primary Transfer Condition

A primary transfer roller (5Y, 5M, 5C, 5K of FIG. 1 (each having 6.05 mm diameter)): the structure in which a metal core was provided with elastic gum: Surface specific resistance 1×10⁶ Ω, and a transfer voltage was applied.

Secondary Transfer Condition

A back-up roller 74 and a secondary transfer roller 5A were disposed to put an endless belt-shaped intermediate transfer member 70 as the intermediate transfer member therebetween, the resistance value of the back-up roller 74 is 1×10⁶ Ω, the resistance value of the secondary transfer roller as a secondary transfer means is 1×10⁶ Ω, and a constant current control (about 80 μLA) was conducted.

Fixing is a heat fixing method by a fixing roller in which a heater was arranged inside of a roller.

A distance Y on an intermediate transfer member from the first contact point between the intermediate transfer member and a photoreceptor to the first contact point between the intermediate transfer member and a photoreceptor for a next color was made 95 mm.

The outer circumferential length (circumferential length) of drive roller 71, guide roller 72,73 and back-up roller 74 for use in secondary transfer was made 31.67 mm (=95 mm/3), and the outer circumferential length of tension roller 76 was made 23.75 mm (=95 mm/4).

And, the outer circumferential length of a primary transfer roller was made 19 mm (=95 mm/5).

Cleaning Blade (Photoreceptor)

A cleaning brush: conductive acryl resin, bristles density of 3×10³/cm², bite-in amount (deformed amount) of 0.6 mm

A secondary transfer roller (5A of FIG. 1): with the structure in which the core metal is provided with elastic rubber: a transfer voltage was applied.

Cleaning Blade (Intermediate Transfer Member)

TABLE 2

| | | Surface | | | | | | | | |
|---|---|---|---|---|---|---|---|---|---|---|
| | | energy | | | | | | | | |
| | | lowering | Rz of | Bite-in | | | | | | |
| | Photo- | agent | intermediate | amount of | Contact | Lacking | Scattering | | | |
| | receptor | (water | transfer | cleaning | angle on | of | of | | | |
| Combination | No. | Content: | member | brush | photo- | partial | character | Cleaning | Image | |
| No. | (Rz: μm) | weight %) | (μm) | (mm) | receptor | image | image | ability | density | Sharpness |
| 1 | 3(1.3) | A(0.05) | 1.5 | 1.0 | 112° | A | B | A | A | A |
| 2 | 3(1.3) | B(0.1) | 1.5 | 1.0 | 112° | A | A | A | A | A |
| 3 | 3(1.3) | C(1.0) | 1.5 | 1.0 | 112° | A | A | A | A | A |
| 4 | 3(1.3) | D(2.5) | 1.5 | 1.0 | 110° | A | A | A | A | A |
| 5 | 3(1.3) | E(4.5) | 1.5 | 1.0 | 106° | B | B | A | A | B |
| 6 | 3(1.3) | F(5.5) | 1.5 | 1.0 | 101° | C | C | B | B | C |
| 7 | 3(1.3) | G(0.8) | 1.5 | 1.0 | 105° | B | A | A | A | B |
| 8 | 1(0.07) | C(1.0) | 0.9 | 0.6 | 105° | B | B | A | A | B |
| 9 | 2(3.0) | C(1.0) | 1.5 | 1.3 | 112° | A | A | A | A | B |
| 10 | 4(0.2) | C(1.0) | 0.9 | 1.3 | 112° | A | A | A | A | A |
| 11 | 5(4.3) | C(1.0) | 1.5 | 1.0 | 105° | C | B | A | A | B |
| 12 | 6(0.03) | C(1.0) | 0.9 | 1.0 | 101° | B | C | A | A | B |
| 13 | 7(1.3) | No | 0.9 | 1.0 | 85° | C | C | C | B | C |

As can be appreciated from table 2, the whole of evaluation items including image racking and character scatterin was improved in combinations 1-5 and 7-12 which were supplied surface energy lowering agent having water content of less than or equal to 4.5 weight %, in comparison with with combination 6 which were supplied surface energy lowering agent having water content of 5.5 weight %. In particular, improvement effect was remarkable in combinations 1-5 and 7-10 of surface energy lowering agent having water content of less than or equal to 4.5 weight % and photo conductor's ten point surface roughness Rz of 0.07-3.0 μm in comparison with combination 6. Further, combinations 1-5 and 7-12 indicate a good result for almost all evaluation items in comparison with combination 13 which did not use surface energy lowering agent.

### Example B

Manufacture of Photoreceptor B1

Manufacturing was the same as photo conductor 1 of

### Example A

Manufacture of Photoreceptor 2

In manufacture of photo conductor B 1, photo conductor B 2 was made similarly except that charge transport layer (CTL) composition liquid was exchanged with the following composition liquid. Rz of photo conductor B 2 was 3.0 μm.

<Charge Transporting Layer (CTL) Composition Liquid>

Manufacturing was the same as photo conductor 2 of

### Example A

Manufacture of Photoreceptor B3

The protective layer composition liquid used for photo conductor 3 was used, and coated as a protective layer of 2 μm drying film thickness on CTL of photo conductor B2, and heating hardening was conducted for them under 130 degrees Celsius for 1 hour, thereby photo conductor B3 was made. Rz of photo conductor B3 was 1.3 μm.

In manufacture of manufacture photo conductor B 1 of photo conductor B4, photo conductor B 4 was made similarly except that charge transport layer (CTL) composition liquid was exchanged with the composition liquid which used for photo conductor 4. Rz of photo conductor B 4 was 0.2 μm.

With regard to surface energy lowering agent A-G, it was the same as example A.

Example of Latex Preparation

Placed into a 5,000 ml separable flask fitted with a stirring unit, a temperature sensor, a cooling pipe, and a nitrogen gas inlet was a surface active agent solution (water based medium) prepared by dissolving 7.08 g of an anionic surface active agent (sodium dodecylbenzenesulfonate-: SDS) in 2,760 g of deionized water, and the interior temperature was raised to 80° C. under a nitrogen gas flow while stirring at 230 rpm. A monomer solution was prepared by adding 72.0 g of the compound, represented by the aforementioned formula 19) (hereinafter referred to as “Exemplified Compound (19) ”) to a mixed monomer solution consisting of 115.1 g of styrene, 42.0 g of n-butyl acrylate, and 10.9 g of methacrylic acid followed by being dissolved while heated to 80° C.

Said heated solution was mixed with and dispersed employing a mechanical type homogenizer, having a circulation channel, and a dispersion containing emulsion particles, having a uniform dispersed particle diameter, was prepared.

Subsequently, a solution prepared by dissolving 0.84 g of a polymerization initiator (potassium persulfate: KPS) in 200 g of deionized water was added to the resulting dispersion, and the resulting mixture was heated to 80° C. and stirred for 3 hours, whereby latex was prepared.

Subsequently, a solution prepared by dissolving 7.73 g of said polymerization initiator (KPS) in 240 ml of deionized water was added to the resulting latex.

After 15 minutes, at 80° C., a monomer mixture solution consisting of 383.6 g of styrene, 140.0 g of n-butyl acrylate, 36.4 g of methacrylic acid, and 14.0 g of n-octylmercapto propionic ester was added dropwise over 120 minutes. After said dropwise addition, the resulting mixture was stirring for 60 minutes, and then cooled to 40° C. Thus latex was obtained.

The resulting latex was designated as “Latex (1)”.

Production Example of Toner

Preparation of Colored Particles 1Bk

Added to 160 ml of deionized water were 9.2 g of sodium n-dodecylsulfate which were stirred and dissolved.

While stirring the resulting solution, 20 g of carbon black, “Regal 330R” (produced by Cabot Corp.), were gradually added, and subsequently dispersed employing a stirring unit, “CLEARMIX” (produced by M Technique Ltd.). The colorant particle diameter of said Colorant Dispersion was determined employing an electrophoresis light scattering photometer “ELS-800” (produced by OTSUKA ELECTRONICS CO., LTD.), resulting in a weight average particle diameter measurement of 112 nm. This dispersion was hereinafter referred to as “Colorant Dispersion (1)”.

Placed into a 5-liter four-necked flask fitted with a temperature sensor, a cooling pipe, a nitrogen gas inlet unit, and a stirring unit were 1250 g of Latex (1) mentioned before, 2000 ml of deionized water, and Colorant Dispersion (1) prepared as previously described, and the resulting mixture was stirred. After adjusting the interior temperature to 30° C., 5 mol/l aqueous sodium hydroxide solution was added to the resulting solution, and the pH was adjusted to 10.0.

Subsequently, an aqueous solution prepared by dissolving 52.6 g of magnesium chloride tetrahydrate in 72 ml of deionized water was added at 30° C. for 5 minutes.

After setting the resulting mixture aside for 2 minutes, it was heated so that the temperature was increased to 90° C. for 5 minutes (at a temperature increase rate of 12° C./minute). While maintaining the resulting state, the diameter of coalesced particles was measured employing a “Coulter Counter TA-II”. When the volume average particle diameter reached 4.3 μm, the growth of particles was terminated by the addition of an aqueous solution prepared by dissolving 115 g of sodium chloride in 700 ml of deionized water, and further fusion was continually carried out at a liquid media temperature of 85±2° C. for 8 hours, while being heated and stirred.

Thereafter, the temperature was decreased to 30° C. at a rate of 6° C./min.

Subsequently, the pH was adjusted to 2.0 by adding hydrochloric acid, and stirring was terminated. The resulting colored particles were filtered, and washed under following condition. Washed particles were then dried by 40° C. air, and thus colored particles were obtained.

The colored particles obtained as previously described were designated as “Colored Particles 1Bk”.

Preparation of Colored Particles 2Bk-11Bk

Colored particles 2Bk-11Bk were prepared in the same manner as Preparation of Colored Particles 1Bk except that the salting out/fusing condition in the preparation method was varied as shown in the Table 3.

TABLE 3

| | | | | | Growing- |
|---|---|---|---|---|---|
| | Dosage of | | Salting- | | stop |
| Colorant | magne- | Temperature | out/Fusion | | particle |
| particle | sium | increasing | Liquid | Holding | diameter |
| No. | chloride | rate | temperature | time | (μm) |
| Colorant | 52.6 g | 12° C./min | 85 ± 2° C. | 8 hour | 4.3 |
| particle | | | | | |
| 1Bk | | | | | |
| Colorant | 52.6 g | 20° C./min | 90 ± 2° C. | 6 hour | 4.3 |
| particle | | | | | |
| 2Bk | | | | | |
| Colorant | 52.6 g | 5° C./min | 90 ± 2° C. | 6 hour | 4.1 |
| particle | | | | | |
| 3Bk | | | | | |
| Colorant | 26.5 g | 12° C./min | 85 ± 2° C. | 8 hour | 4.3 |
| particle | | | | | |
| 4Bk | | | | | |
| Colorant | 78.9 g | 12° C./min | 85 ± 2° C. | 8 hour | 4.3 |
| particle | | | | | |
| 5Bk | | | | | |
| Colorant | 52.6 g | 12° C./min | 85 ± 2° C. | 8 hour | 3.5 |
| particle | | | | | |
| 6Bk | | | | | |
| Colorant | 38.6 g | 12° C./min | 85 ± 2° C. | 8 hour | 3.4 |
| particle | | | | | |
| 7Bk | | | | | |
| Colorant | 78.9 g | 12° C./min | 85 ± 2° C. | 8 hour | 3.2 |
| particle | | | | | |
| 8Bk | | | | | |
| Colorant | 52.6 g | 12° C./min | 85 ± 2° C. | 8 hour | 5.6 |
| particle | | | | | |
| 9Bk | | | | | |
| Colorant | 45.8 g | 12° C./min | 85 ± 2° C. | 8 hour | 6.8 |
| particle | | | | | |
| 10Bk | | | | | |
| Colorant | 52.6 g | 12° C./min | 85 ± 2° C. | 8 hour | 8.9 |
| particle | | | | | |
| 11Bk | | | | | |

One weight percent of hydrophobic silica (having a number average primary particle diameter of 12 nm and a degree of hydrophobicity of 68) and one weight percent of hydrophobic titanium oxide (having a number average primary particle diameter of 20 nm and a degree of hydrophobicity of 63) were added to each of the resultant Colored Particles 1Bk through 11Bk, and each of said resultant mixtures was mixed employing a Henschel mixer, whereby Toners 1Bk through 11Bk, were obtained.

Physical properties such as the shape and diameter of each toner were shown in Table 4. These each toner was mixed with silicone carrier to use as two component developer, and each developer was referred corresponding to each toner. The developer reference using toner 1Bk is two component developers 1Bk, and each developer was given the reference number same as developer 1Bk.

Further, as for mean particle size, physical property such as particle size distribution, even if either coloring particle being prototype of toner or toner (external additives were usually added for coloration particle) are measured, there is no substantial difference in the value.

TABLE 4

| | 50% | 50% | | Cumulative | Cumulative | | Number % |
|---|---|---|---|---|---|---|---|
| | volume | number | | 75% volume | 75% number | | of |
| | average | average | | average | average | | particles |
| | particle | particle | | particle | particle | | not |
| | diameter | diameter | | diameter | diameter | | larger |
| | (Dv50) | (Dp50) | | (Dv75) | (Dv75) | | than |
| Toner No. | (μm) | (μm) | Dv50/Dp50 | (μm) | (μm) | Dv75/Dp75 | 0.7 × Dp50 |
| Toner 1Bk | 4.6 | 4.3 | 1.07 | 4.1 | 3.8 | 1.08 | 7.8 |
| Toner 2Bk | 4.8 | 4.5 | 1.07 | 4.2 | 3.7 | 1.14 | 5.5 |
| Toner 3Bk | 4.4 | 4.0 | 1.10 | 4.0 | 3.4 | 1.18 | 8.2 |
| Toner 4Bk | 4.6 | 3.8 | 1.21 | 4.0 | 3.1 | 1.29 | 13.6 |
| Toner 5Bk | 4.7 | 4.3 | 1.09 | 4.1 | 3.6 | 1.14 | 6.3 |
| Toner 6Bk | 3.5 | 3.1 | 1.13 | 3.1 | 2.8 | 1.11 | 6.8 |
| Toner 7Bk | 3.8 | 3.4 | 1.12 | 3.3 | 2.7 | 1.23 | 12.4 |
| Toner 8Bk | 3.6 | 3.3 | 1.09 | 3.1 | 2.8 | 1.11 | 6.3 |
| Toner 9Bk | 5.8 | 5.3 | 1.09 | 5.1 | 4.5 | 1.13 | 8.4 |
| Toner 10Bk | 7.1 | 6.4 | 1.11 | 6.3 | 5.3 | 1.19 | 11.0 |
| Toner 11Bk | 9.3 | 8.8 | 1.06 | 7.9 | 6.9 | 1.14 | 6.3 |

<Evaluation>

A cleaning means shown in FIG. 5 was mounted as a cleaning means for a photoreceptor of a digital color printer having an intermediate transfer member of FIG. 1, a kind of a photoreceptor, a kind of surface energy lowering agent, and a kind of an intermediate transfer member was combined in the digital color printer as shown in combinations in table 5. An image of pixel rate 8% was printed on 100000 sheets of A4 size paper continuously under a high-temperature of 30° C. and a high humidity of 80% RH by the printer, and the printed sheets were evaluated. Evaluation items are evaluations for the lacking of partial toner image and the scattering of character image, a cleaning-ability evaluation, and an image quality evaluation.

Evaluation items and criterion for evaluation are shown below.

TABLE 5

| | Surface | | | | |
|---|---|---|---|---|---|
| | energy | | | | |
| | lowering | | | Rz of | |
| | agent | | Photo- | intermediate | Bite-in |
| | (water | | receptor | transfer | amount of |
| Combination | content: | Toner | No. | member | cleaning |
| No. | weight %) | No. | (Rz: μm) | Rz: μm | brush (mm) |
| 1 | C(1.0) | 1 | 1(0.07) | 0.9 | 0.6 |
| 2 | C(1.0) | 2 | 4(0.2) | 0.9 | 1.3 |
| 3 | C(1.0) | 3 | 3(1.3) | 1.5 | 1.0 |
| 4 | C(1.0) | 4 | 3(1.3) | 1.5 | 1.0 |
| 5 | C(1.0) | 5 | 3(1.3) | 1.5 | 1.0 |
| 6 | C(1.0) | 6 | 3(1.3) | 1.5 | 1.0 |
| 7 | C(1.0) | 7 | 3(1.3) | 1.5 | 1.0 |
| 8 | C(1.0) | 8 | 3(1.3) | 1.5 | 1.0 |
| 9 | C(1.0) | 9 | 3(1.3) | 1.5 | 1.0 |
| 10 | C(1.0) | 10 | 3(1.3) | 1.5 | 1.0 |
| 11 | C(1.0) | 11 | 3(1.3) | 1.5 | 1.0 |
| 12 | A(0.05) | 2 | 3(1.3) | 1.5 | 1.0 |
| 13 | B(0.1) | 2 | 2(3.0) | 1.5 | 0.6 |
| 14 | D(2.5) | 2 | 3(1.3) | 1.5 | 1.3 |
| 15 | E(4.5) | 2 | 3(1.3) | 1.5 | 1.0 |
| 16 | F(5.5) | 2 | 3(1.3) | 1.5 | 1.0 |
| 17 | No | 2 | 3(1.3) | 1.5 | 1.0 |

Evaluation Item and Criterion for Evaluation

These were the same in Example A.

Other Conditions for Evaluation

These were the same in EXAMPLE A.

TABLE 6

| | Contact | Lacking | Scattering | | | |
|---|---|---|---|---|---|---|
| | angle on | of | of | | | |
| Combination | photo- | partial | character | Cleaning | Image | |
| No. | receptor | image | image | ability | density | Sharpness |
| 1 | 108° | A | A | A | A | A |
| 2 | 106° | A | A | A | A | B |
| 3 | 108° | A | A | A | A | A |
| 4 | 100° | C | C | B | B | C |
| 5 | 108° | A | A | A | A | A |
| 6 | 108° | A | B | A | A | B |
| 7 | 102° | C | C | B | B | B |
| 8 | 108° | A | A | A | A | A |
| 9 | 108° | A | A | A | A | A |
| 10 | 104° | C | B | B | B | B |
| 11 | 106° | B | A | A | A | B |
| 12 | 110° | A | A | A | A | A |
| 13 | 110° | A | A | B | A | B |
| 14 | 106° | A | A | A | A | A |
| 15 | 100° | B | B | A | A | B |
| 16 | 87° | C | C | B | B | C |
| 17 | 82° | C | C | C | B | C |

| | | Surface | | | | | | | | |
|---|---|---|---|---|---|---|---|---|---|---|
| | | energy | | | | | | | | |
| | | lowering | Rz of | Bite-in | | | | | | |
| | Photo- | agent | intermediate | amount of | Contact | Lacking | Scattering | | | |
| | receptor | (water | transfer | cleaning | angle on | of | of | | | |
| Combination | No. | content: | member | brush | photo- | partial | character | Cleaning | Image | |
| No. | (Rz: μm) | weight %) | (μm) | (mm) | receptor | image | image | ability | density | Sharpness |
| 1 | 3(1.3) | A(0.05) | 1.5 | 1.0 | 112° | A | B | A | A | A |
| 2 | 3(1.3) | B(0.1) | 1.5 | 1.0 | 112° | A | A | A | A | A |
| 3 | 3(1.3) | C(1.0) | 1.5 | 1.0 | 112° | A | A | A | A | A |
| 4 | 3(1.3) | D(2.5) | 1.5 | 1.0 | 110° | A | A | A | A | A |
| 5 | 3(1.3) | E(4.5) | 1.5 | 1.0 | 106° | B | B | A | A | B |
| 6 | 3(1.3) | F(5.5) | 1.5 | 1.0 | 101° | C | C | B | B | C |
| 7 | 3(1.3) | G(0.8) | 1.5 | 1.0 | 105° | B | A | A | A | B |
| 8 | 1(0.07) | C(1.0) | 0.9 | 0.6 | 105° | B | B | A | A | B |
| 9 | 2(3.0) | C(1.0) | 1.5 | 1.3 | 112° | A | A | A | A | B |
| 10 | 4(0.2) | C(1.0) | 0.9 | 1.3 | 112° | A | A | A | A | A |
| 11 | 5(4.3) | C(1.0) | 1.5 | 1.0 | 105° | C | B | A | A | B |
| 12 | 6(0.03) | C(1.0) | 0.9 | 1.0 | 101° | B | C | A | A | B |
| 13 | 7(1.3) | No | 0.9 | 1.0 | 85° | C | C | C | B | C |

Result

When water content of surface energy lowering agent provided to the surface of electrophotography photo conductor was lower than 4.5 weight % and combinations with preferred toner are 1-3, 5, 6, 8, 9 and 11-15, the whole of evaluation items including image lacking and character scattering was improved in comparison with combination 16 which was supplied surface energy lowering agent having water content of 5.5 weight %. Further, the whole of evaluation items including image lacking and character scattering was improved in combination 1-3, 5, 6, 8, 9 and 11-15 of embodiment using preferred toner in comparison with combination 4, 7, 10 of embodiment using toner being not preferred. In particular, improvement effect was remarkable in combination 1-3, 5, 6, 8, 9 and 11-14 as for combination of surface energy lowering agent having water content of less than or equal to 2.5 weight % and preferable toner. Combination 17 which did not use surface energy lowering agent indicates inferior result in almost all evaluation items.

### Example C

In manufacture of toner used in example, six kinds of toners 1Y, 1M, 1C, 4Y, 4M, 4C showin in Table 6 and having shape coefficient similar to toners 1Bk and toner 4Bk were manufactured similarly, except that B, C.I. pigment yellow 185 (Y toner), C.I. pigment red 122 (M toner), C.I. pigment blue 15:3 (C toner) were used instead of Regal 330R (carbon black made in Cabot Corp.) of coloring dispersion liquid.

TABLE 7

| | 50% | 50% | | Cumulative | Cumulative | | Number % |
|---|---|---|---|---|---|---|---|
| | volume | number | | 75% volume | 75% number | | of |
| | average | average | | average | average | | particles |
| | particle | particle | | particle | particle | | not |
| | diameter | diameter | | diameter | diameter | | larger |
| Toner | (Dv50) | (Dp50) | | (Dv75) | (Dp75) | | than |
| No. | (μm) | (μm) | Dv50/Dp50 | (μm) | (μm) | Dv75/Dp75 | 0.7 × Dp50 |
| Toner 1Y | 4.6 | 4.3 | 1.07 | 4.0 | 3.8 | 1.05 | 7.8 |
| Toner 1M | 4.6 | 4.3 | 1.07 | 4.2 | 3.9 | 1.08 | 7.9 |
| Toner 1C | 4.6 | 4.3 | 1.07 | 4.1 | 3.8 | 1.08 | 7.8 |
| Toner 4Y | 4.6 | 3.8 | 1.21 | 4.0 | 3.1 | 1.29 | 13.6 |
| Toner 4M | 4.6 | 3.9 | 1.17 | 4.0 | 3.2 | 1.25 | 13.2 |
| Toner 4C | 4.6 | 3.8 | 1.21 | 4.0 | 3.0 | 1.33 | 14.6 |

Manufacturing of a Developer

Evaluation-use developer 1Y, 1M, 1C, 4Y, 4M, 4C were produced by mixing 10 weight parts of each of above toner 1Y, 1M, 1C, 4Y, 4M and 4C and 100 weight parts of 45 μm ferrite carrier covered with styrene-methacrylate copolymer

By using one group of these developers 1K, 1Y, 1M and 1C and four groups of developers 4K, 4Y, 4M and 4C, image evaluation similar to example B was conducted.

In this regard, the surface energy lowering agent was unified to C, the photo conductor was unified to B3, Rz of intermediate transfer member was unified to 1.5, binding amount of cleaning was unified to 11.0 mm and other condition was the same as example B, and then 10000 pieces of color image was printed with an intermediate transfer method.

As a result, as for the color image with the use of one developer, an image having good sharpness was obtained without image defect such as image lacking and character scattering. Degradation of sharpness proceeded in the color image with the use of four group of developers.

As shown in the examples, an improvement of a toner transfer characteristic of an electrophotographic method with the use of an intermediate transfer member can be achieved, an image defect such as lacking of partial toner image and scattering of character image caused by the lowering of toner transfer can be prevented, and an electrophotographic method type image forming device a good cleaning characteristic can be offered.

What is claimed is:

1. An image forming method, comprising steps of:
developing a latent image on an electrophotographic photoreceptor with a developer containing toners; and
providing a surface energy lowering agent having a water content ratio of 5.0 weight % or less onto the surface of the photoreceptor.

2. The image forming method of claim 1, wherein the photoreceptor has a ten point surface roughness Rz of 0.05 to 4.0 μm.

3. The image forming method of claim 1, further comprising:
a first transferring step of transferring a toners image from the photoreceptor to an intermediate transfer member, and
a second transferring step of transferring the toners image from the intermediate transfer member to a recording material.

4. The image forming method of claim 1, wherein the surface energy lowering agent includes fatty acid metal salt.

5. The image forming method of claim 4, wherein the fatty acid metal salt contains zinc stearate.

6. The image forming method of claim 1, wherein the surface energy lowering agent includes fluororesin containing fluorine atom.

7. The image forming method of claim 1, wherein a surface layer of the photoreceptor contains particles having a number average particle diameter of 5 nm to 8 μm.

8. The image forming method of claim 1, wherein a surface layer of the photoreceptor contains particles having a number average particle diameter of 5 nm to 8 μm and the photoreceptor has a ten point surface roughness Rz of 0.05 to 4.0 μm.

9. An image forming method, comprising:
developing a latent image on an electrophotographic photoreceptor with a developer containing toners, wherein the toners has a ratio (Dv50/Dp50) of 1.0 to 1.15, where Dv50 is 50% volume particle diameter and Dp50 is 50% number particle diameter; and
providing a surface energy lowering agent having a water content ratio of 5.0 weight % or less onto the surface of the photoreceptor.

10. The image forming method of claim 9, wherein the toners has a ratio (Dv75/Dp75) of 1.0 to 1.2, where Dv75 is a cumulative 75% volume particle diameter from the larger side of the volume particle diameters and Dp75 is a cumulative 75% number particle diameter from the larger side of the number particle diameters.

11. The image forming method of claim 10, wherein the number of the toners having a particle diameter of 0.7× (Dp50) or less is 10 number % or less.

12. The image forming method of claim 11, wherein the surface energy lowering agent includes fatty acid metal salt.

13. The image forming method of claim 12, wherein the fatty acid metal salt contains zinc stearate.

14. The image forming method of claim 12, wherein the toners have a number average particle diameter of 3.0 to 8.5 μm.

15. The image forming method of claim 1, wherein the photoreceptor has a ten point surface roughness Rz of 0.05 to 4.0 μm.

16. The image forming method of claim 9, further comprising:
a first transferring step of transferring a toners image from the photoreceptor to an intermediate transfer member, and
a second transferring step of transferring the toners image from the intermediate transfer member to a recording material.

17. The image forming method of claim 9, wherein the surface energy lowering agent includes fatty acid metal salt.

18. The image forming method of claim 17, wherein the fatty acid metal salt contains zinc stearate.

19. The image forming method of claim 9, wherein the surface energy lowering agent includes fluororesin containing fluorine atom.

20. The image forming method of claim 9, wherein the toners have a number average particle diameter of 3.0 to 8.5 μm.

21. The image forming method of claim 9, wherein the photoreceptor has a ten point surface roughness Rz of 0.05 to 4.0 μm.

22. The image forming method of claim 9, wherein a surface layer of the photoreceptor contains particles having a number average particle diameter of 5 nm to 8 μm.

23. An image forming apparatus, comprising:
an electrophotographic photoreceptor on which a latent image is formed; and
an agent providing device to provide a surface energy lowering agent having content ratio of 5.0 weight % or less onto the surface of the photoreceptor.

24. The image forming apparatus, further comprising:
a developing device to develop the latent image with a developer containing toners, wherein the toners has a ratio (Dv50/Dp50) of 1.0 to 1.15, where Dv50 is 50% volume particle diameter and Dp50 is 50% number particle diameter.
